(19) United States
(12) Patent Application Publication
(10) Pub. No.: US 2003/0071075 A1
(43) Pub. Date: Apr. 17, 2003

(54) Aqueous fabric care compositions for effective use away from the home and accessories for use therewith

(76) Inventors: Gayle Marie Frankenbach, Cincinnati, OH (US); Toan Trinh, Maineville, OH (US); Ray Douglas Lotts, Loveland, OH (US); Yuko Nakamura, Kobe (JP); Anneke Margaret Kaminski, Cincinnati, OH (US); Sarah Marie Young, Cincinnati, OH (US); Alan Robert Dinniwell, Mason, OH (US); Ted John Fitz, Cincinnati, OH (US); Elise Marie Boehm, Cincannati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/126,899

(22) Filed: Apr. 19, 2002

Related U.S. Application Data
(60) Provisional application No. 60/285,794, filed on Apr. 23, 2001.

(51) Int. Cl. B67D 5/40

(52) U.S. Cl. 222/383.1

(57) ABSTRACT

An article containing an aqueous fabric care composition and a container for the composition to facilitate portability and encourage effective use of the composition away from the home. Also provided are kits including the acticles of the present invention in combination with one or more optional accessories including hangers, compression devices, weights, portable mats, air blowers, gloves, mitts, mini-irons and combinations thereof.

### CROSS REFERENCE TO RELATED APPLICATIONS

This application claims priority under 35 U.S.C. §119(e) to U.S. Provisional Applcation Serial No. 60/285,794, filed Apr. 23, 2001 (Attorney Docket No. 8527P).

A portion of the disclosure of this patent document contains material that is subject to copyright protection. The copyright owner has no objection to the facsimile reproduction by any one of the patent disclosure, as it appears in the Patent and Trademark Office patent files or records, but otherwise reserves all copyright rights whatsoever.

### TECHNICAL FIELD

The present invention relates to aqueous compositions and a container to facilitate the portability and effective use of such compositions during travel. The present invention further relates to various optional accessories for facilitating the effective use of the aqueous compositions during travel. The aqueous compositions that are elements of the articles, kits and methods of the present invention include various aqueous-based fabric care compositions, including wrinkle-control compositions and fabric refreshing compositions.

### BACKGROUND OF THE INVENTION

In the modern world people lead busy lives often requiring significant time away from their domiciles. This time away from the home will include overnight travel, day trips or merely the running of errands. During these many outings it would often be convenient to have access to compositions to support a person's daily needs for cleanliness, maintenance, and personal care of themselves, their dependents, and possessions. Often compositions to support such daily needs are not transported on trips because portability and use of these compositions is not convenient, and in some cases are ineffective when used outside the home.

Many compositions for maintenance, cleanliness, and personal care of self, dependents, and possessions are aqueous-based compositions because water is available, inexpensive, safe, non-toxic, environment friendly, low-viscosity, and compatible with a variety of components. However, a negative of aqueous compositions is that they flow very well and tend to leak from containers, particularly when exposed to changes in air pressure, e.g. during flight, or travel between areas with significantly different altitudes. Another difficulty of aqueous based compositions is that water is dense, causing such compositions to be heavy and difficult to transport in larger quantities. Water's density and low viscosity tend to make aqueous compositions inconvenient for travel and portability.

While smaller sizes are typically preferred for travel, reducing the size below a lower limit introduces surprising negatives including container stability and ineffective application of the composition amongst others. Specifically, the upright stability of the container is compromised when a container that is too small is coupled with a spray dispenser that will provide a uniform spray pattern. The geometry of the smaller containers needs to be carefully considered to maintain upright stability. Smaller sizes are also ineffective with certain preferred trigger sprayers because the container fails to provide adequate surface area for griping the container while triggering. Further, it has been found that smaller volume containers unexpectedly encourage users to dispense the compositions at sub-minimum levels resulting in ineffective and disappointing results. Likewise, containers and dispensers that are difficult or uncomfortable to use further exacerbate the tendency to ineffectively dose the compositions.

Consumer use of fabric care compositions to clean, maintain and refresh fabrics is typically restricted to use in the home. However, there is a plethora of opportunites in which the use of such compositions outside the home would benefit the consumer. Overnight and day travel represent but a few of these as the conducting of everyday errands, such as travel to the laundrymat, to church and/or business events also present opportunities where the consumer would benefit from the ability to use various fabric care compositions. The articles, kits and methods of the present invention are intended to promote the effective use of such compositions outside the home.

### SUMMARY OF THE INVENTION

The present invention provides an article for improving the portability and effective use of aqueous fabric care compositions away from the home, such fabric care compositions selected from the group consisting of wrinkle control compositions, fabric refreshing compositions and mixtures thereof and a container having a volume capacity between about 400 mL and about 100 mL, preferably between about 350 mL and about 180 mL, and more preferably between about 300 mL and about 200 mL, said container having a spray dispenser that will provide a uniform spray pattern for dispensing the aqueous composition on fabrics.

The uniform spray patterns of the articles of the present invention have a volume per unit surface area of less than about 0.07 ml/inch² (0.011 ml/cm²), preferably less than about 0.05 ml/inch²(0.0078 ml/cm²), more preferably less than about 0.035 ml/inch² (0.0054 ml/cm²), even more preferably less than about 0.025 ml/inch² (0.0039 ml/cm²), and still more preferably less than about 0.02 ml/inch² (0.0031 ml/cm²). In the alternative or in addition thereto, the uniform spray patterns of the articles of the present invention have a standard deviation in the volume per unit surface area of less than about 0.056 ml/inch² (0.0087 ml/cm²), preferably less than about 0.05 ml/inch² (0.0078 ml/cm²), more preferably less than about 0.03 ml/inch² (0.0047 ml/cm²), even more preferably less than about 0.022 ml/inch² (0.0034 ml/cm²), and still more preferably less than about 0.02 ml/inch² (0.0031 ml/cm²); and yet still more preferably less than about 0.018 ml/inch² (0.0028 ml/cm²). In the alternative or in addition thereto, the uniform spray patterns of the articles of the present invention have a Trouton ratio, at the extension and shear rates of less than about 20,000 s⁻¹, should be less than about 10,000, preferably less than about 5,000, more preferably less than about 1,000, even more preferably less than about 500, and still more preferably less than about 100.

The present invention also provides a travel kit, comprising an article of the present invention and a protective enclosure for containing the article during travel. Preferably, the protective enclosure has a moisture barrier to inhibit the trasmission of moisture therethrough. Optionally, the kits of the present invention further comprise at least one travel accessory to facilitate the effective use of the aqueous composition on fabrics, said travel accessories may include container lids, hangers, compression devices, weights, application pads, air blowers, gloves, mini-irons, and combinations thereof. Likewise, the kits of the present invention may optionally comprise a container for containing additional volume of an aqueous fabric care composition.

The articles and kits of the present invention may optionally further comprise instructions concerning the use of fabric care compositions away from the home. Optional markings on the article and the various elements of the kit may be provided to link compositions with accessories and with instructions for use. Since written instruction are likely to be separated from the compositions, accessories, and packaging, markings will play an important role in giving the user confidence that the appropriate elements are being used together effectively.

### BRIEF DESCRIPTION OF DRAWINGS

FIG. 1 is a front view of a kit of the present invention shown in an open configuration.

FIG. 2 is rear view of the kit shown in FIG. 1.

FIG. 3 is a perspective view of an optional compression device for inclusion in a kit of the present invention.

FIGS. 4a-4b are respectively an overview and cross sectional view of a portable mat in its use configuration.

FIGS. 5a-5b are respectively a side view of a portable mat in its travel configuration and an overview of a folding portable surface in its use configuration.

FIG. 6 is an illustration of optional instructions concerning the use of the articles and kits of the present invention.

FIG. 7a is an overview of an optional strap-on mitt accessory of the kits of the present invention.

FIG. 7b is an overview of an optional mitt accessory of the kits of the present invention.

FIG. 8 is an overview of an optional glove accessory of the kits of the present invention.

FIG. 9 is a schematic view of an apparatus for conducting the Patternator Test method.

FIG. 10a is a three dimensional graphical plot of a spray pattern for a spray dispenser useful in the present invention. FIG. 10b. is a cross sectional view of the plot of FIG. 10a.

FIG. 11a. is a three dimensional graphical plot of a spray pattern for a spray dispenser useful in the present invention. FIG. 11b. is a cross sectional view of the plot of FIG. 11a.

FIG. 12a. is a three dimensional graphical plot of a spray pattern for a spray dispenser useful in the present invention. FIG. 12b. is a cross sectional view of the plot of FIG. 12a.

FIG. 13a. is a three dimensional graphical plot of a spray pattern for a spray dispenser useful in the present invention. FIG. 13b. is a cross sectional view of the plot of FIG. 13a.

FIG. 14a. is a three dimensional graphical plot of a spray pattern for a spray dispenser useful in the present invention. FIG. 14b. is a cross sectional view of the plot of FIG. 14a.

FIG. 15a. is a three dimensional graphical plot of a spray pattern for a spray dispenser useful in the present invention. FIG. 15b. is a cross sectional view of the plot of FIG. 15a.

FIG. 16 is a graphical illustration of the percetage of compostion remaining on treated fabric as a function of time wherein an assortment of spray dispsensers have been used.

FIGS. 17a and 17b are side views of the tilt tester used to determine the parallel and perpendicular tilt angles of the containers of the present invention.

### DETAILED DESCRIPTION OF THE INVENTION

On trips away from the domicile, it is often desirable to have the convenience of various aqueous compositions for maintenance, cleanliness, and care of the self, dependents, and possessions. However, users often neglect to use such compositions when traveling because the portability of such compositions is inconvenient and/or the use of such compositions is ineffective.

Kits provide a useful means of combining elements of the present invention. Kits comprise essentially, the aqueous composition and the optimally sized containers together with one or more of the following optional elements 1) accessories for use with general aqueous compositions, 2) accessories use with for specific aqueous compositions, 3) instructions for use, 4) packaging to contain kit elements, 5) identifying markings, and 6) combinations thereof.

Several accessories are disclosed that make portability and use of aqueous compositions more convenient and effective include optimally-sized containers, dispensers with uniform spray patterns, travel enclosures, and re-fill containers. Additionally, accessories that ease the burden of travel and portability of general aqueous compositions for treating fabrics and aqueous compositions for treating aqueous wrinkle control compositions are disclosed.

Instructions for use are further included in the present invention. Instructions provide the user with a means to achieve adequate education to use the accessories and compositions appropriately to derive the full potential of the composition, accessories, kits, and benefits thereof. Instructions alert the user to opportunities for portability and best practices for effectively using such compositions away from the home.

Another aspect of the present invention is identifying markings. Identifying markings link aqueous compositions, accessories, instructions instructions for use, and kit packaging together. Since the various accessories, containers, instructions, and packaging can become separate, identifying marking play an important role in giving the user confidence that the appropriate elements are being used together.

### I. Articles

A. Aqueous Compositions

Aqueous compositions comprise water from any source including, but not limited to, tap water, distilled water, chemically or mechanically purified water, and deionized water. The present invention also relates to concentrated compositions that are diluted by the user with available water to generate the finished composition for use. The highest level of water in the composition is 100% but typically the water content between about 99.975% and about 10% by weight of the usage composition. It is acceptable for concentrated compositions to comprise from about 0% to about 95% water.

Additional optional components are added to the aqueous composition to generate compositions with a variety of functionality. A nonlimiting list of functional benefits that can be provided through the effective use of such compositions includes: a) for fabrics and/or surfaces—wrinkle control, ironing aid, color rejuvenation and/or maintenance, odor control or elimination, stain removal or reduction, adjusting fabric feel (e.g. crispness, softness, silkiness), insect or pest repellent, perfuming, freshening; germ kill, cleaners, polishers b) personal care—cleansers for various parts of the anatomy, moisturizers, leave-in or rinse-out hair conditioner, styling aids for hair, perfume, sun block, pest repellent, make-up, various skin conditioning products.

Specialized Fabric Care Aqueous Compositions

1. Wrinkle Control Compositions

Wrinkle control compositions are intended to remove wrinkles from fabrics and/or prevent wrinkles from returning to fabrics during use. The disclosure of U.S. Ser. No. 09/799,146 and Ser. No. 09,799,228, both filed Mar. 5, 2001 by Frankenbach et al. concerning various fabric wrinkle control compositions is incorporated herein by reference as if fully set forth herein. Additional nonlimiting examples of wrinkle control compositions incorporated herein by reference are disclosed in U.S. Pat. No. 2,789,379, issued Apr. 23, 1957 to L. B. Edwards, et al.; U.S. Pat. No. 3,600,325 issued Aug. 17, 1971 to K. L. Kaufman et al.; U.S. Pat. No. 3,674,688 issued Jul. 4, 1972 to L. Schwartz et al.; U.S. Pat. No. 4,139,661 issued Feb. 13, 1979 to D. B. Anagnostis, et al.; U.S. Pat. No. 4,857,212 issued Aug. 15, 1989 to Ona et al.; U.S. Pat. No. 5,645,751 issued Jul. 8, 1997 to K. S. Haley; U.S. Pat. No. 5,968,404 issued Oct. 19, 1999 to Trinh et al.; U.S. Pat. No. 6,001,343 issued Dec. 14, 1999 to Trinh et al.; Japanese Kokai Patent Application No. HEI 10[1998]-46471 (or Hei 8[1996]-197788) published Feb 17, 1998 by H. Nomura; and Japanese Kokai Patent Application No. 5[1993]-239,774 (or Hei 4[1992]-35083) published Sep. 17, 1993 by H. Hasegawa. Further examples are found in U.S. Pat. No. 5,573,695, issued Nov. 12, 1996 to E. F. Targosz which discloses an aqueous wrinkle removal composition containing a vegetable oil based cationic quaternary ammonium surfactant, and an anionic fluorosurfactant. Similarly, U.S. Pat. No. 4,661,268, issued Apr. 28, 1987 to Jacobson et al. discloses a wrinkle removal spray comprising an aqueous alcoholic composition containing a dialkyl quaternary ammonium salt and a silicone surfactant and/or a fluoro surfactant. U.S. Pat. No. 5,100,566, issued Mar. 31, 1992 to Agbomeirele et al., discloses a method of reducing wrinkles in fabric by spraying the fabric with an aqueous alcoholic solution of an anionic siliconate alkali metal salt. U.S. Pat. No. 4,806,254, issued Feb. 21, 1989 to J. A. Church discloses fabric wrinkle removal aqueous alcoholic solution containing glycerine and a nonionic surfactant. U.S. Pat. No. 5,532,023, issued Jul. 2, 1996 to Vogel et al. discloses aqueous wrinkle control compositions containing silicone and film forming polymer.

2. Odor Control Compositions

Odor control compositions remove odors from clothes. The compositions for odor control are preferably of the type disclosed in U.S. Pat. No. 5,534,165, issued Jul. 9, 1996; U.S. Pat. No. 5,578,563, issued Nov. 26, 1996; U.S. Pat. No. 5,663,134 issued Sep. 2, 1997; U.S. Pat. No. 5,668,097 issued Sep. 16, 1997; U.S. Pat. No. 5,670,475 issued Sep. 23, 1997; and U.S. Pat. No. 5,714,137, issued Feb. 3, 1998; all issued to Trinh et al. and incorporated herein by reference. Such compositions can contain several different optional odor control agents in addition to polymers that control amine odors. Freshcare™ fabric refresher available from the Clorox Corporation and Resolve® Fabric Refresher available from Reckitt and Colman both exemplify typical nonlimiting examples of odor control compositions.

3. Fabric Softening Compositions

Fabric softening compositions make fabrics feel more comfortable and soft in use. Compositions for fabric softening comprise water and fabric softener actives as described in the U.S. Ser. No. 09/309,128, filed May 10, 1999 and Ser. No. 09/554,969 filed May 23, 2000, both by Frankenbach et al. and incorporated herein by reference. It is acceptable for aqueous fabric softening compositions to comprise fabric softener actives that are saturated, unsaturated, or a mixture thereof. Typically, these compositions will comprise at least about 0.25% fabric softener active, preferably at least about 0.5% fabric softener active and less than about 20% fabric softener active.

Preferred Optional Components

While water is the only essential ingredient of such aqueous compositions, there are optional ingredients that are preferred for incorporation depending on the purpose of the composition.

4. Perfume

Aqueous compositions of the present invention can optionally incorporate perfume to provide scent as one or more primary benefit(s) or these can also incorporate perfume as a “scent signal” in the form of a pleasant odor that provides a freshness impression. Suitable perfumes for compositions disclosed in the present invention, including hydrophilic perfumes and low-odor detection perfumes, are disclosed in detail in International Publication Nos. WO 01/07710 A1, Frankenbach et al., published Feb. 1, 2001, WO 99/55953 A1, Trinh et al., published Nov. 4, 1999; U.S. Ser. No. 09/309,128, Frankenbach et al., filed May 10, 1999, and Ser. No. 09/805,099, Frankenbach et al., filed Mar. 13, 2001. The level of perfume incorporated is dependent on the purpose of incorporation.

5. Antimicrobial

Optionally, but preferably, solubilized, water-soluble, antimicrobial preservative can be added to the composition of the present invention because these aqueous products may be prime breeding grounds for certain microorganisms, especially when in aqueous compositions. This drawback can lead to the problem of storage stability of these solutions for any significant length of time. Contamination by certain microorganisms with subsequent microbial growth can result in an unsightly and/or malodorous solution. Because microbial growth in aqueous solutions is highly objectionable when it occurs, it is highly preferable to include a solubilized, water-soluble, antimicrobial preservative, which is effective for inhibiting and/or regulating microbial growth in order to increase storage stability of the preferably clear, aqueous consumer products such as the subject product of this patent. Preferred antimicrobial preservatives are those that are water-soluble and are effective at low levels. Water-soluble preservatives useful in the present invention are those that have a solubility in water of at least about 0.3 g per 100 ml of water, i.e., greater than about 0.3% at room temperature, preferably greater than about 0.5% at room temperature. Preferred levels of preservative are from about 0.0001% to about 0.5%, more preferably from about 0.0002% to about 0.2%, most preferably from about 0.0003% to about 0. 1%, by weight of the usage composition.

The preservative can be any organic preservative material that will not cause damage to fabric appearance, e.g., discoloration, coloration, bleaching. Preferred water-soluble preservatives include organic sulfur compounds, halogenated compounds, cyclic organic nitrogen compounds, low molecular weight aldehydes, quaternary ammonium compounds, dehydroacetic acid, phenyl and phenolic compounds, alcoholic solvents and mixtures thereof.

Anti-microbial materials useful for the present invention are disclosed in U.S. Pat. No. 6,106,738, issued Aug, 22, 2000, Woo et al.; U.S. Pat. No. 6,033,679, issued Mar. 7, 2000, Woo et al.; U.S. Pat. No. 6,001343, issued Dec. 14, 1999, Trinh et al.; U.S. Pat. No. 5,997,759, issued Dec. 7, 1999, Trinh et al.; U.S. Pat. No. 5,981,455, issued Nov. 9, 1999, Carrie et al.; U.S. Pat. No. 5,968,404, issued Oct. 19, 1999, Trinh et al.; U.S. Pat. No. 5,955,093, issued Sept. 21, 1999, Woo et al.; U.S. Pat. No. 5,942,217, bissued Aug. 24, 1999, Woo et al; U.S. Pat. No. 5,939,060, issued Aug. 17, 1999, Trinh et al.; U.S. Pat. No. 5,783,544, issued Jul. 21, 1998, Trinh et al.; U.S. Pat. No. 5,830,845, issued Nov. 3, 1998, Trinh et al.; U.S. Pat. No. 5,714,137, issued Feb. 3, 1998, Trinh et al.; International Publication No. WO 01/07710 A1, Frankenbach et al., published Feb. 1, 2001; and U.S. Ser. No. 09/805,099, filed Mar. 13, 2001; Ser. No. 09/610,561, filed Jul. 5, 2000; Ser. No. 09/634,379, filed Aug. 9, 2000; and Ser. No. 09/799,146, filed Mar. 5, 2001, Frankenbach et al., all of which are incorporated by reference herein.

6. Surfactant and Emulsifiers

Surfactants and/or emulsifiers acceptable for the present invention are detailed in International Publication Nos. WO 01/07710 A1, published Feb. 1, 2001; WO 99/55953 A1, Trinh et al. published Nov. 4, 1999; and U.S. Ser. No. 09/805,099, filed Mar. 13, 2001; Ser. No. 09/610,561, filed Jul. 5, 2000; Ser. No. 09/634,379, filed Aug. 9, 2000; Ser. No. 09/799,146, filed Mar. 5, 2001, Frankenbach et al., all of which are incorporated by reference herein.

7. Silicones

A highly preferred, but nonlimiting class of silicones surfactants useful for the present invention is the class of silicone polyethers alternately know as dimethicone copolyols and polyalkylene oxide polysiloxanes. Suitable silicones for use in fabric care compositions are detailed in International Publication Nos. WO 01/07710 A1, Frankenbach et al., published Feb. 1, 2001; WO 99/55953 A1, Trinh et al. published Nov. 4, 1999, and U.S. Ser. No. 09/805,099, filed Mar. 13, 20001; 09/610,561, filed Jul. 5, 2000; Ser. No. 09/634,379, filed Aug. 9, 2000; Ser. No. 09/799,146, filed Mar. 5, 2001 by Frankenbach et al., all of which are incorporated herein by reference.

8. Shape Retention Polymers

Shape retention polymers cceptable for the present invention are detailed in U.S. Pat. No. 5,532,023, issued Jul. 2, 1996 and U.S. Pat. No. 5,798,107, issued Aug. 28, 1998 both by A. M. Vogel, et al.; U.S. Pat. No. 5,968,404, granted Oct. 19, 1999, and U.S. Pat. No. 6,001,343, granted Dec. 14, 1999, both by T. Trinh et al.; International Publication Nos. WO 01/07710 A1, Frankenbach et al., published Feb. 1, 2001; WO 99/55953 A1, Trinh et al. Pub. Nov. 4, 1999; and U.S. Ser. No. 09/805,099, filed Mar. 13, 20001; Ser. No. 09/610,561, filed Jul. 5, 2000; Ser. No. 09/634,379, filed Aug. 9, 2000; Ser. No. 09/799,146, filed Mar. 5, 2001, Frankenbach et al., all of which are incorporated by reference herein.

9. Cyclodextrin

As used herein, the term “cyclodextrin” includes any of the known cyclodextrins such as unsubstituted cyclodextrins containing from six to twelve glucose units, especially, alpha-cyclodextrin, beta-cyclodextrin, gamma-cyclodextrin and/or their derivatives and/or mixtures thereof. Cyclodextrins are of the type disclosed in U.S. Pat. No. 6,106,738, issued Aug. 22, 2000, Woo et al.; U.S. Pat. No. 6,033,679, issued Mar. 7, 2000, Woo et al.; U.S. Pat. No. 6,001343, issued Dec. 14, 1999, Trinh et al.; U.S. Pat. No. 5,997,759, issued Dec. 7, 1999, Trinh et al.; U.S. Pat. No. 5,981,455, issued Nov. 9, 1999, Carrie et al.; U.S. Pat. No. 5,968,404, issued Oct. 19, 1999, Trinh et al.; U.S. Pat. No. 5,955,093, issued Sept. 21, 1999, Woo et al.; U.S. Pat. No. 5,942,217, issued Aug. 24, 1999, Woo et al; U.S. Pat. No. 5,939,060, issued Aug. 17, 1999, Trinh et al.; U.S. Pat. No. 5,783,544, issued Jul. 21, 1998, Trinh et al.; U.S. Pat. No. 5,830,845, issued Nov. 3, 1998, Trinh et al.; U.S. Pat. No. 5,714,137, issued Feb. 3, 1998, Trinh et al.; all of said patents are incorporated herein by reference.

10. Additional Odor Control Agents

Additional optional odor control can be provided by including low molecular weight polyols, metal salts, soluble bicarbonate or bicarbonate salts, enzymes, zeolites, all forms of activated carbon (including fibers) and water soluble polymers. Additional odor control agents are of the type disclosed in U.S. Pat. No. 6,106,738, issued Aug, 22, 2000, Woo et al.; U.S. Pat. No. 6,033,679, issued Mar. 7, 2000, Woo et al.; U.S. Pat. No. 6,001,343, issued Dec. 14, 1999, Trinh et al.; U.S. Pat. No. 5,997,759, issued Dec. 7, 1999, Trinh et al.; U.S. Pat. No. 5,981,455, issued Nov. 9, 1999, Carrie et al.; U.S. Pat. No. 5,968,404, issued Oct. 19, 1999, Trinh et al.; U.S. Pat. No. 5,955,093, issued Sept. 21, 1999, Woo et al.; U.S. Pat. No. 5,942,217, issued Aug. 24, 1999, Woo et al; U.S. Pat. No. 5,939,060, issued Aug. 17, 1999, Trinh et al.; U.S. Pat. No. 5,783,544, issued Jul. 21, 1998, Trinh et al.; U.S. Pat. No. 5,830,845, issued Nov. 3, 1998, Trinh et al.; U.S. Pat. No. 5,714,137, issued Feb. 3, 1998, Trinh et al.; all of said patents are incorporated herein by reference.

11. Solvents and Plasticizers

Solvents and plasticizers can be incorporated for a variety of reasons and are selected depending on the functionality of the fabric care composition. Often solvents and/or plasticizers have multiple functionality and indeed a solvent may also act as a plasticizers and vice versa. Some nonlimiting purposes for incorporating solvents and plasticizers include decreasing fabric drying time, increasing the effectiveness of antimicrobial agents, and softening fabric fibers where adhesive and/or film forming polymers are used. Low molecular weight polyols with high boiling points relative to that of water, are preferred optional ingredients for improving odor control performance when cyclodextrin is present. Solvents and plasticizers are also useful for aiding in increasing the solubility and/or miscibility of a variety of components into aqueous compositions. As a nonlimiting example, solvents and plasticizers are useful at increasing the miscibility of quaternary ammonium compounds in water. Such use of hydrophilic plasticizers and low moleculear weight polyols are described in WO 99/55953 A1, Trinh et al., published Nov. 4, 1999. Descriptions of solvents and plasticizers are also disclosed in U.S. Ser. No. 09/805,099, Frankenbach et al., filed Mar. 13, 2001. These descriptions of solvents and plasticizers are incorporated herein by reference.

When optional solvents and/or plasticizers are included these are typically present at less than about 20%, preferably less than about 10%, more preferably less than about 5%, even more preferably about 3% or less and typically at a level greater than about 0.1%, and preferably greater than about 0.5% by weight of the composition.

12. Optional Insect and/or Moth Repelling Agent

The composition of the present invention can optionally contain an effective amount of insect and/or moth repelling agents. Typical insect and moth repelling agents are pheromones, such as anti-aggregation pheromones, and other natural and/or synthetic ingredients. Preferred insect and moth repellent agents useful in the composition of the present invention are perfume ingredients, such as citronellol, citronellal, citral, linalool, cedar extract, geranium oil, sandalwood oil, 2-(diethylphenoxy)ethanol, 1-dodecene, etc. Other examples of insect and/or moth repellents useful in the composition of the present invention are disclosed in U.S. Pat. No. 4,449,987 issued May 22, 1984 to Lindauer; U.S. Pat. No. 4,693,890 issued Sept. 15, 1987 to Wilson et al.; U.S. Pat. No. 4,696,676 issued Sept. 29, 1998 to Wilson et al.; U.S. Pat. No. 4,933,371 issued Jun. 12, 1990 to Hink et al.; U.S. Pat. No. 5,030,660 issued Jul. 9, 1991 to Norris et al.; U.S. Pat. No. 5,196,200 issued Mar. 23, 1993 to Wilson et al; and in “Semio Activity of Flavor and Fragrance Molecules on Various Insect Species”, B. D. Mookherjee et al., published in Bioactive Volatile Compounds from Plants, ASC Symposium Series 525, R. Teranishi, R. G. Buttery, and H. Sugisawa, 1993, pp. 35-48, all of said patents and publications being incorporated herein by reference. When an insect and/or moth repellent is used it is typically present at a level of from about 0.005% to about 3%, by weight of the usage composition.

B. Containers

When an article is not convenient or produces ineffective results, users will not use it or incorporate it into their daily activities. This is especially true when consumer must also transport the product during trips away from the home and when the user must store the product in locations away from the home. Improving the convenience of portability and storage makes it easier for the user to take the composition wherever they go and store it wherever they might use it. Dispensers that provide uniform spray patterns are needed to promote effective use of the compositions during travel by reducing dry time and the tendency for staining.

1. Container Size

Fabric care composition containers require more optimization on size. While small containers are useful for a variety of travel and transport situations due to the convenience of packing and transporting smaller items, such containers fail to provide adequate volumes of fabric care compositions compared to when such containers are used to contain fragrances, personal care products or other aqueous compositions. Further, fabric care compositions are preferably applied with spray dispensers that require a mininum size container to ensure stability of the container and to provide needed ergonomics during use. The use of large containers to contain fabric care compositions is not appropriate for use outside the home, as such containers are inconvenient for packing, storage and are too heavy transport.

Containers that are smaller than the typical 500 mL size provide many advantages as they are more convenient to store and pack during both long and short trips. Smaller containers fit more easily in luggage, tots, and purses and are easier to store in modes of transport, e.g. the car. Smaller containers may be used in a variety of situations away from home, such as trips to the physical fitness facilities, trips to work, as smaller containers are easier to store in tight places like lockers and desks. Smaller containers are typically less expensive and therefore more accessible for purchase by consumers of limited economic means. For all these reasons, small containers not only provide convenience, but also encourage habitual usage and thus support increases in consumption.

However, smaller is not always better and there is a lower limit to the size of containers that will provide a combination of convenience and effective use during travel. Specifically, containers that are too small do not provide enough composition to treat a reasonable number of garments. Moreover, when the container is too small, the consumer tends to use less product in order to conserve it thereby compromising the performance of the composition. In addition, containers that are too small tend to be less stable in an upright position, particularly when coupled with a spray dispenser that can provide a uniform distribution of the composition during application. Further as containers become smaller, the cost of packaging becomes an ever increasing percentage of the total cost and users become less likely to make a purchase as packaging size becomes smaller because they perceive the value is reduced.

2. Container Stability

One measure of an appropriately sized container is the upright stability of the container when the container is pared with a spray dispenser. Upright stability is not only important to the end user, but also important to the economics of making and shipping the article. Containers that tilt too easily tend to fall over during production slowing production. Further, when containers are smaller, more packing materials are needed to guarentee the article remains upright during shipping to prevent leakage and loss of composition. Thus, a more stable package will yield savings in production time, packing material and shipping weight.

Upright stability determines how easily a product is stored in the upright position. Products with good upright stability are less likely to fall over when grasped by the user. Upright stability can be measured by the tilt stability test method described hereinafter. To test upright stability several samples of an empty container together with the dispenser is placed on a tilting platform, with the platform set at 0° (parallel to the horizontal). The platform is then tilted at an angle of 2° per second. The angle at which the bottle tips is then noted. Containers are tested for tilt stability in two positions, first with the dispenser perpendicular to the electric eye beam used to detect the bottle tip, and second with the sprayer parallel to the eye beam. The latter case where the the trigger sprayer is perpendicular to the electric eye beam models the situation where the user grasps the container since the grasping motion will apply a force parallel to the direction that the dispenser is pointing.

Containers useful in the articles and kits of the present invention will remain upright at a rise of equal to or greater than about 10° in at least one test position and preferably will remain upright at equal to or greater than 10° in both test positions. More preferably, the container will remain upright in both test positions equal to or greater than about 15°, even more preferably equal to or greater than about 20°, and still more preferably equal to or greater than about 30°.

However, the tilt angles for many of the containers tended to differ for each of the two positions tested. Therefore, other preferred containers will include those that remain upright at equal to or greater than 15° in one of the positions while remaining upright at equal to or greater than about 10° in the other. More preferably, such containers will remain upright at equal to or greater than about 20° in one of the positions while remaining upright at equal to or greater than about 10° in the other. Still more preferred will be containers that will remain upright at equal to or greater than about 30° in one position and equal to or greater than about 10° in the other position. It is also preferred that the position where the eye beam is perpendicular to the direction of the spray dispenser have the higher tilt angle since this configuration simulates the direction of the force that user would use to grasp the container. Tilt Stability data for sample containers is presented in Example V along with additional data to describe containers.

Upright stability is also facilitated when the container has a sufficiently large foot-print. The foot-print is the surface area that is enclosed when the bottom of the container contacts a surface. Optionally, but preferably the surface area is closed or continuous. Typically, the surface area enclosed by the foot-print is at least 10 cm², preferably at least 15 cm², more preferably at least about 20 cm² and still more prefereably at least about 25 cm².

Another factor that contributes to the upright stability of the container is the center of gravity. In general, containers having a lower center of gravity tend to be more stable. In this context, “lower center of gravity” is intended to refer to containers that have at least 50% of their mass when filled, at or below the median point of their height. Preferred containers will have at least about 65% of their mass below the median point of their height and even more preferred containers will have at least about 70% of their mass below the median point of their height.

The containers useful in the articles of the present invention contain a volume of equal to or less than about 500 mL, preferably less than about 350 mL, and more preferably less than about 300 mL. Such containers will also contain at least about 100 mL, preferably at least about 120 mL, more preferably at least about 200 mL, and even more preferably at least about 230 mL of the composition.

3. Spray Dispenser Providing Uniform Spray Pattern

A dispenser is combined with the container, the dispenser being selected from the group of dispensers including pumps, pressurized aerosols, and manually and non-manually operated trigger sprayers including pre-compression sprayers. Preferably, the dispenser is a trigger sprayer. Regardless of the type of dispenser used, it is preferred that it provide a uniform distribution pattern as disclosed in more detail below.

It is difficult to produce a connection between a container and a dispenser that does not leak under common travel conditions. Therefore, it is preferable to provide a lid capable of sealing the container more tightly than the spray dispenser, especially when the dispenser is non-permanently attached to the container such as by screw-on or snap-on attachment.

Providing a uniform spray pattern has many benefits. Dispensers that provide a uniform spray pattern increase the performance of the compositions by improving the likelihood of achieving adequate distribution across the entire surface to be treated. Uniform spray patterns reduce dry time and the potential for staining due to uneven distribution. Uniform distribution is especially critical when the aqueous compositions are to be used away from the home when it is less likely that users will be able to clean or substitute items that are stained by the improper application of a composition. The needs to reduce dry time and to avoid staining are particularly important with items of clothing that are worn against the skin and are viewed and scrutinized by others.

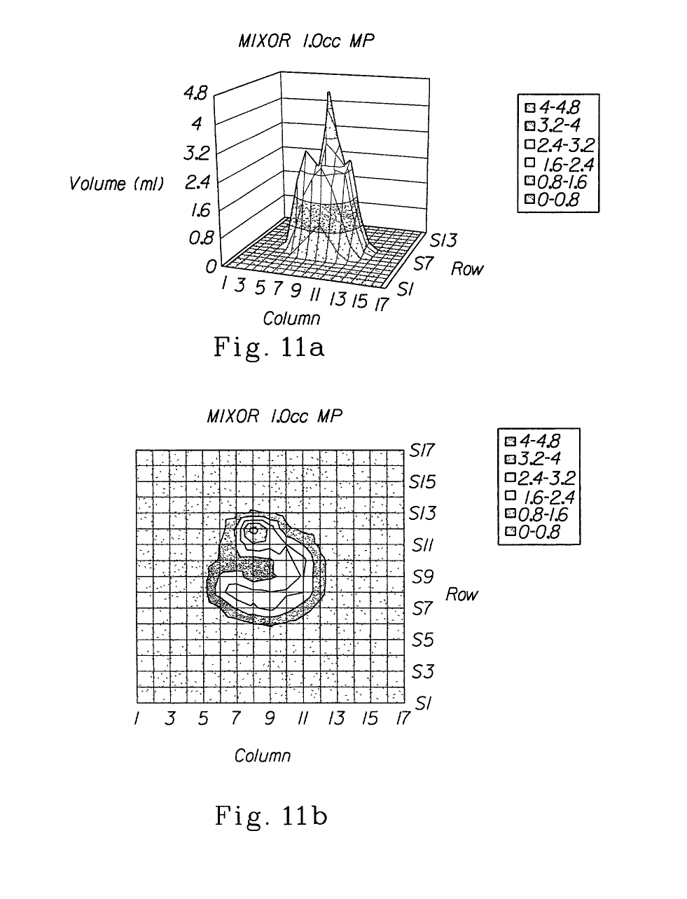

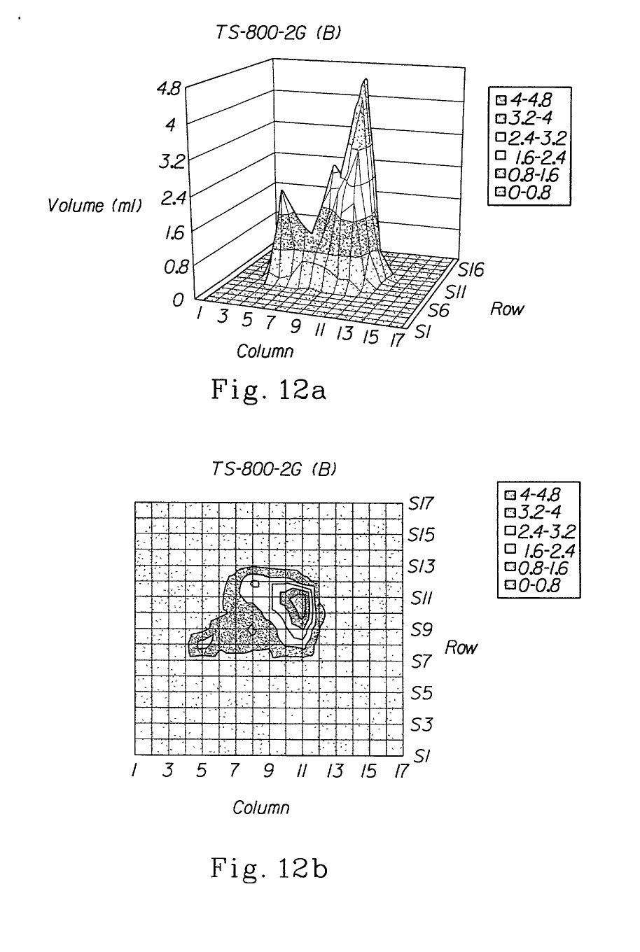

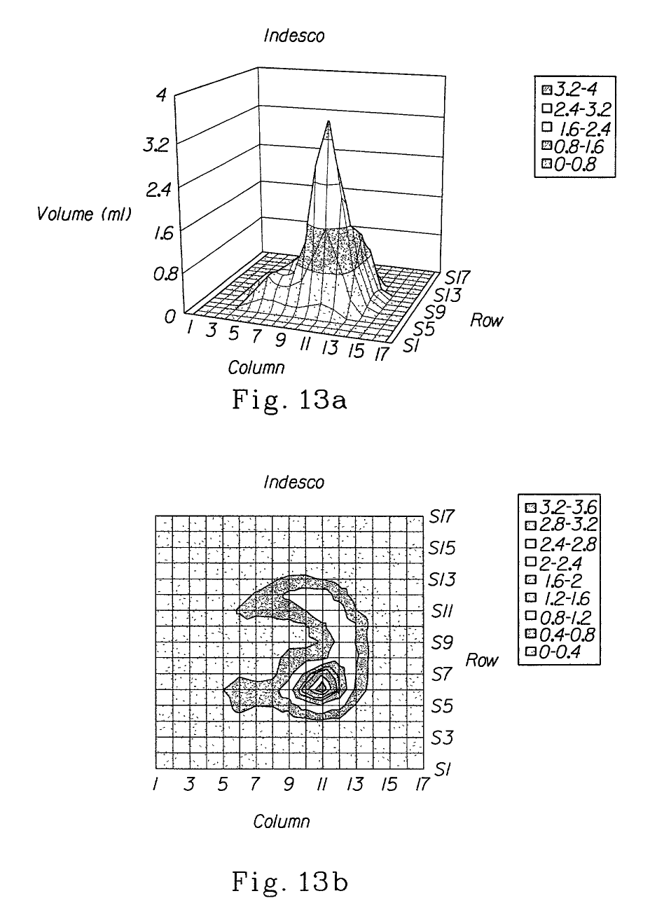

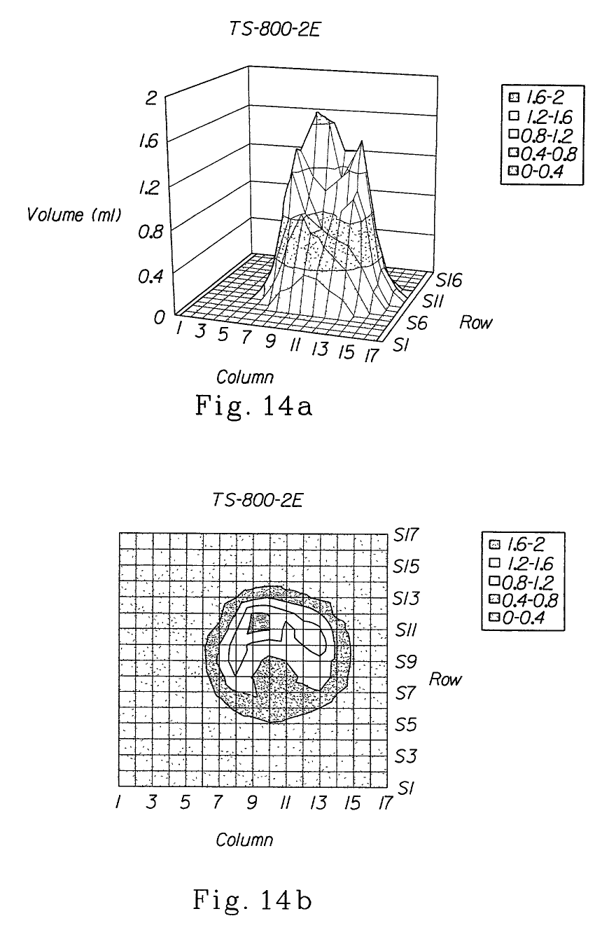

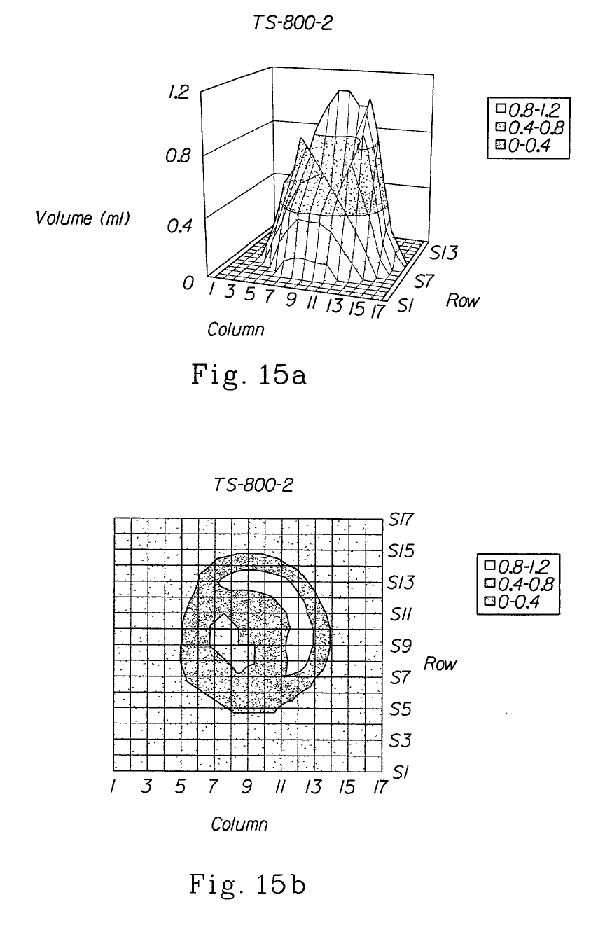

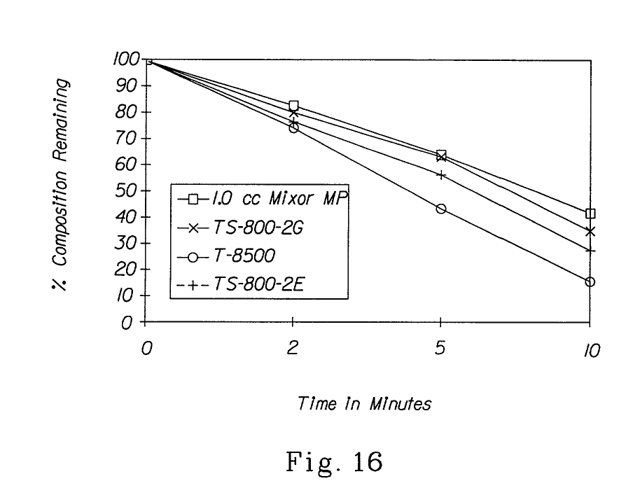

The key parameter effective in minimizing staining and reducing dry time is to achieve uniform distribution of the aqueous compositions over the surface area. This principle is demonstrated for fabrics in the tables and plots found in FIGS. 11a-16b. Uniform distribution in a spray pattern is measured as: the volume of product dispensed per unit of surface area and the standard deviation in the volume deposited per unit of surface area. To achieve uniform distribution, the dispenser chosen must be capable of producing an acceptable spray pattern that falls within the limits of volume of product dispensed per unit area and on the standard deviation in volume per unit surface area disclosed herein.

The composition can also contribute to achieving a good distribution pattern. Not to be bound by theory, but as the extensional viscosity of the product increases, it becomes more difficult for particles to separate on spraying and the cone angle of the spray collapses resulting in the liquid dispensing over a smaller area on the surface, and thereby forming ‘hot spots.’ Therefore, the product composition must meet certain requirements for extensional viscosity. Extensional viscosity is typically expressed as the Trouton ratio which is the ratio of extensional viscosity to shear viscosity.

There are many techniques that can be used to measure the extensional rheology of fluids, and they usually fall into two categories. The first category contains “flow through” devices, and the second one contains “stagnation point” devices. Note that it is more accurate to call the measuring equipment “indexers” rather than “rheometers”, since with extensional measurement equipment the stress response is not usually free of extraneous stress contributions.

Most of the first devices rely on the fluid being spinnable, like the tubeless siphon, and spinning techniques. These techniques are usually limited to low rates of strain and to generally highly viscous or elastic fluids. Therefore, their applicability to spraying may be limited. Examples of the spinning techniques are fiber spinning, “falling droplet” or “filament stretching”. Alternatively, orifice flow techniques, which measure the pressure drop across a contraction, can be used for fluids that cannot be spinned. However, the interpretation of the data is not straightforward even for Newtonian fluids. For non-Newtonian fluids, the difficulty is even more pronounced as recirculating vortices and viscoelastic instabilities are present. Other variations of the flow technique are those of flow through “packed beds” or “screen packs”. Increased flow resistance through beds or packs indicates the presence of extensional viscosity. However, rather than measuring an absolute value, the flow through screen packs yields a relative index of extensional viscosity.

On the other hand, the stagnation point devices, such as the roll mill, lubricated-die converging flow rheometer, cross-slot cell, and the opposing jet device can be used to study the extensional behavior of low-viscosity fluids. The Rheometrics RFX rheometer (Rheometric Scientific Inc., Piscataway, N.J.) is an opposing-jet device that is commercially available. Finally, comparison of the extensional viscosity data from the various devices that were referred above is difficult due to the different strain history that each device subjects the sample to, it is expected that the viscosity results will be scattered considerably.

Spray dispensers that provide an acceptably uniform spray pattern dispense a volume per unit surface area of less than about 0.07 ml/inch² (0.011 ml/cm²); preferably less than about 0.05 ml/inch²(0.0078 ml/cm²); more preferably less than about 0.035 ml/inch² (0.0054 ml/cm²); even more preferably less than about 0.025 ml/inch² (0.0039 ml/cm²); and still more preferably less than about 0.02 ml/inch² (0.0031 ml/cm²); and/or a standard deviation in the volume per unit surface area of less than about 0.056 ml/inch² (0.0087 ml/cm²); preferably less than about 0.05 ml/inch² (0.0078 ml/cm²); more preferably less than about 0.03 ml/inch² (0.0047 ml/cm²); even more preferably less than about 0.022 ml/inch² (0.0034 ml/cm²); still more preferably less than about 0.02 ml/inch² (0.0031 ml/cm²); and yet still more preferably less than about 0.018 ml/inch² (0.0028 ml/cm²).

The Trouton ratio, at the extension and shear rates of less than about 20,000 s⁻¹, should be less than about 10,000, preferably less than about 5,000, more preferably less than about 1,000, even more preferably less than about 500, and most preferably less than about 100.

Optionally, but highly preferably, the dispenser is a trigger sprayer. Since trigger sprayers are easier to operate than sprayers requiring pressure to be placed by a single finger, these make portability more convenient and use away from the home more effective. Suitable spray dispensers used to provide the desired spray pattern herein include, but are not limited to, the Indesco T-8500 available from Continental Sprayers Inc.; the TS-800-2 and the TS-800-2E available from Calmar, Inc.

C. Optional Instructions for Use

The articles of the present invention can optionally comprise a set of instructions in association with the article. A detailed description of such associated instructions is provided below in conjunction with the description of the kits of the present invention.

### II. Travel Kits

While in transport, it often happens that containers may leak, wetting or soiling various items transported therewith. Therefore, an optional enclosure that is capable of reversibly enclosing the container and containing any spillage that may result will improve the convenience of traveling with wrinkle-control and other fabric care compositions. In addition, several other accessories of the present invention may optionally be included in a kit of the present invention to make travel and portability of wrinkle control compositions more convenient, thus encouraging consumption. Further, still, since smaller containers tend to run out of composition sooner than larger containers, it is optional but preferable to have a re-fill container that carries a re-fill of the composition and/or difference fabric care compositions together in the kits of the present invention.

A. Articles of the Present Invention

The kits of the present invention will contain one or more of the articles of the present invention as described hereinabove in combination with one or more of the following optional accessories. The optional accessories are intended to facilitate the portability and effective use of the aqueous compositions. Accessories render travel and portability easier when used in conjunction with specific aqueous compositions, such as compositons for controlling wrinkles and/or refereshing fabrics. Accessories such as protective enclosures, specialized hangers, compressible devices for suspending fabric, and hand-held blowers aid travel and portability when used together with aqueous compositions for general fabric treatment. Accessories such as fabric weights, mini-irons, portable mats, and hand articles all improve the ease of travel and portability of aqueous compositions for wrinkle control. These accessories are discussed in more detail below.

B. Optional Accessories

1. Accessories for Use with Aqueous Compositions for General Fabric Treatment

Aqueous compositions for treating fabric are designed to provide a variety of functionalities, including, but not limited to odor removal or control, wrinkle control, adjusting the fabric feel, such as imparting softness. When aqueous compositions are utilized to treat fabrics, typically there is a need to either suspend fabrics or lay them on a substantially horizontal surface to expose the maximum surface area of the fabric. Specialized hangers and compressible and reduced-sized devices are useful for suspending fabrics especially when the devices allow the fabrics to be rotated for ease of treating both sides. Air blowers provide a means for increasing the rate of drying fabrics by blowing air across the fabrics.

(a) Protective Enclosures

The essential features of a protective enclosure useful in the kits of the present invention are a moisture barrier to prevent the transmission of moisture through the enclosure walls and and a reclosable seal to allow access to the interior of the enclosure. A preferred type of enclosure is a pouch.

As stated above, it is difficult to produce a closure between a container and spray dispenser that always prevents leakage. Travel pouches are designed to check or restrain spillage or leaks that might occur especially during transit. Through this benefit, travel pouches make it more convenient and likely that packaged aqueous compositions will be taken and used outside the home. Travel pouches keep the accessories and essentials for treating fabrics with aqueous composition together and organized in one place so that they can be easily located in luggage for convenient use.

Optionally, the travel pouches can enclose a variety of other optional items that would be useful to travelers, including but not limited to re-fill containers, additional fabric care items such as materials for repairing fabrics (needle and thread), cleaning products, stain removal products, malodor removal products; personal care and hygiene items such as products for cleansing, catemenials, corrective lens, accessories for care of corrective lens, toilet paper, anti-bacterial wipes, oral care products, skin care products, beauty care products, hair care products, comb, hair brush, body odor control products, hair removal accessories, manicure accessories, sunblock, vitamins, medications, towels; other items; compressible hangers, clothing, clock/watch, flashlight, utensils, multipurpose tool, compass, compressible pillow, plastic bags, compressible clothesline, water purifier, dark glasses, accessories for writing, reading material, maps, necessary travel and/or identification documents, currency, checks, credit cards, umbrellla, cameras, film and combinations thereof.

The height, length, and depth dimensions of the travel pouch are all at least about 1 cm, preferably at least about 5 cm and more preferably at least about 7 cm. The height, length, and depth of the travel kit are also less than about 200 cm, preferably equal to or less than about 100 cm, more preferably equal to or less than about 75 cm, even more preferably equal to or less than about 50 cm and most preferably equal to or less than about 30 cm. The exact dimensions of the travel pouch depends on the number and types of items that the pouch is designed to contain. Travel pouches are typically large enough to enclose a volume equal to or greater than about 100 cc, more preferably, the travel pouch is large enough to enclose a volume of at least about 200 cc, most preferably the travel pouch is large enough to enclose a volume of greater than about 230 cc.

The travel pouch comprises a reversible closure mechanism. Optionally, the travel pouch may comprise means to transport by attachment to or gripping with a part of the anatomy, e.g. handles, straps. When the travel pouch is large, wheels and a handle for pulling are optionally added. The travel pouch can further comprise means to suspend the pouch and contents wherever it would be convenient for use, such as by a hook or loop.

The travel pouch can comprise subdivisions and reversible restraints, or a combination thereof to facilitate the organization of items to be contained. When subdivisions are used, it is preferred that one or more of the subdivisions be waterproof. Optionally, the travel pouch can comprise a liquid absorbent lining or padding for capturing and retaining spillage during transport. It is anticipated that this absorbent member will be removable for drying or disposing where the absorbent member is disposable.

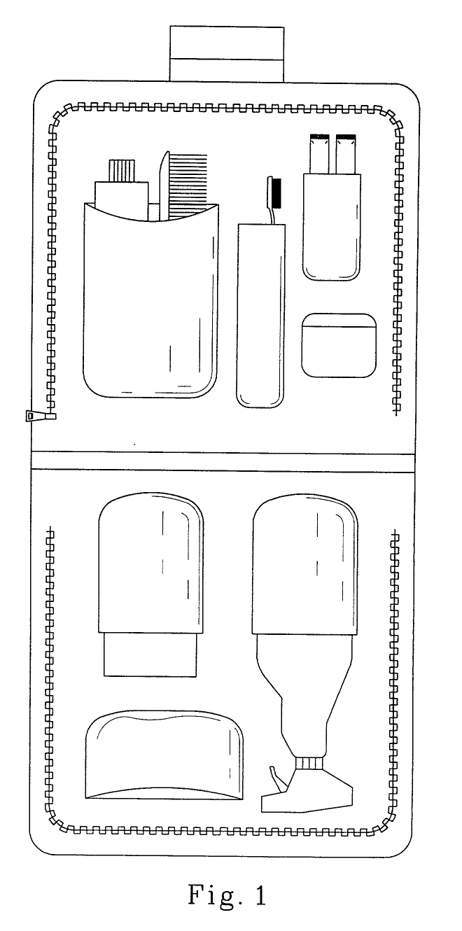

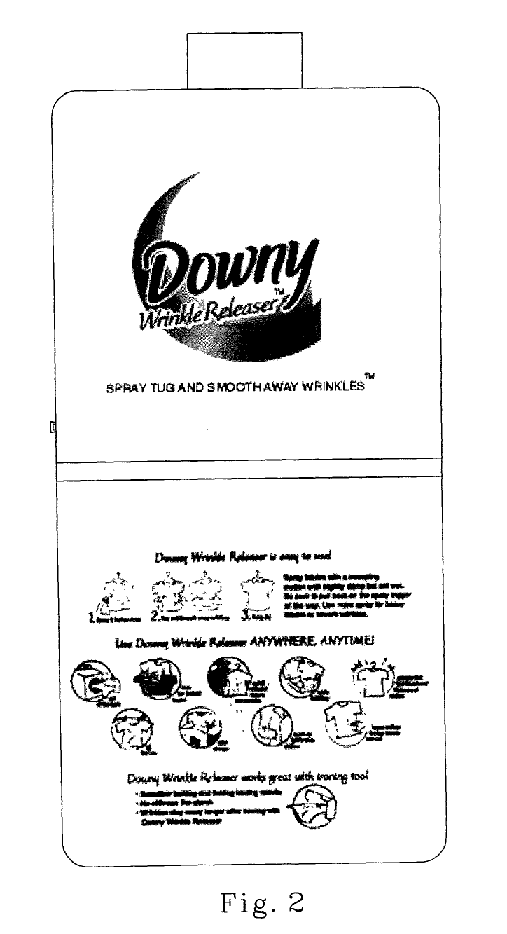

Some nonlimiting examples of commercially available travel pouches include: Square Rigger Laptop attaches, the hanging toilet kit, packing modules, toiletry kit, small duffel bag, Four Suiter luggage, shoulder sachets all available from Lands' End® Direct Merchants and published in the October 2000 catalogue and Healthy Back Bags™, waist packs, convertible microfiber carryalls, toiletries kits, waterproof camera cases, all available from TravelSmith™. Other nolimiting examples of travel pouches are depicted in FIGS. 1 and 2 as elements of travel kits.

(b) Specialized Hangers and Compressible Devices for Suspending Fabrics

Conventional and specialized hangers provide a framework that provides ease of use during treatment of fabrics. Hangers acceptable for use in the kits of the present invention are those designed to facilitate portability and ease of use.

Preferably, the hangers can suspend a variety of fabrics including, but not limited to shirts, skirts, bed linens, table linens, curtains, and pants. It is desirable to preserve the appearance of the fabric also once these are hung, so hangers should be sufficiently strong so they do not sag under the weight of the fabrics. Preferably, specialized hangers include elements for the reversible attachment of fabrics thereto with such attachment elements either permanently or reversibly connected to the specialized hangers. Hangers useful in the kits of the present invention should not cause visible damage to fabric and more preferably should prevent such damage. A nonlimiting approach to preventing fabric damage is to reduce pressure at points where the fabric contacts the specialized hanger.

As nonlimiting examples, specialized hangers designed to hold shirts or pants will preferably have a thick smooth rod or padding where the shoulders of the shirt or the legs of the pants contact the support arms of the hanger so as not to leave indentations or creases in the fabrics. Preferably, hangers designed to hold shirts have sloped arms and/or are substantially triangular in shape to accommodate the shoulders. Preferably hangers that are designed to hold for instance pants, curtains, bed linens or table linens have a horizontal bar. When clips are used to hold fabrics on the hanger, they should not be sharp or apply too much pressure.

Preferably hangers useful in the present invention will have rotation means that will all rotation between the upper portion of the hanger or hang point and the lower portion of the hanger from which fabrics are suspended. Optionally, hangers with a swivel or other rotation means can have means to provide resistance or a locking mechanism that will prevent or inhibit rotation from a desired position. Optionally, specialized hangers have devices that redirect downward force in a substantially horizontal direction to pull out wrinkles. Optionally, the specialized hanger can serve other functions such as the nonlimiting example of a specialized hanger called the Lenox Travel Hanger available from Signals® which folds into a compressed form and doubles as a lint brush. Another commercially available fabric framework is the Hook 'N Hang available from the As Seen On TV Showroom accessed via the world wide web at http://www.tv-showroom.com/html/HooknHang.htm on Aug. 26, 2000 at 2:43 pm. Still other fabric frameworks include clotheslines used together or independently with clothespins.

(c) Air Blowers

Increasing the air flow across a fabric is typically helpful in accelerating the drying time of treated fabrics to improve the convenience of using the wrinkle control composition. Not to be bound by theory, but flowing air carries water vapor away from the surface of a fabric, thus continually driving the equilibrium between water liquid and water vapor towards water vapor at the fabric surface.

Manually or mechanically driven devices that generate a stream of air across a fabric are acceptable for use in the kits of the present invention. Preferably, the air blowing devices generate a constant stream of air across the fabric and can further provide temperature adjustment of the air stream. Preferably, an air blower useful in the kits of the present invention will have a small size, preferably having no dimension greater than about 30 cm. Some nonlimiting examples of devices that are acceptable for the present invention include: hair dryers, especially travel-sized hair dryers and small fans or small air compressors. Preferably the air blower is compressible such that it achieved a smaller configuration when compressed for ease of travel and portability.

(d) Combinations of Accessories for Use with General Aqueous Compostions for Fabric Treatment

Combining accessories for use with general aqueous compositions for fabric treatment is also acceptable for the present invention.

2. Accessories for Use with Aqueous Wrinkle-Control Compositions

Wrinkle control compositions are designed to reduce wrinkles in fabric and to prevent the return of said wrinkles after treatment of fabric. Several accessories are disclosed that make portability more convenient and their use more effective by reducing the work associated with removing wrinkles and/or by reducing negatives, such as contact between skin and composition or overspray onto unintended surfaces.

(a) Fabric Weights

Fabric weights are generally used to eliminate work associated with fabric manipulation by substituting the force of gravity for the force applied by hand manipulation. However fabric weights also provide improved dewrinkling performance beyond that which is typically achieved with hand manipulation. Additionally, fabric weights also reduce or remove a consumer negative as many consumers prefer not to get wrinkle control compositions on their hands.

Fabric weights are devices that increase the force applied to fabrics by gravity by increasing the mass of the fabrics at critical points on the fabric construction to smooth wrinkles out of fabrics. While fabric weights are generally useful on all surfaces of fabrics to smooth fabrics, these are especially useful on challenge areas of fabrics to remove wrinkles. Fabric weights are attachable to the fabric surface by a reversible means while the fabric is suspended such that the force of gravity across the fabric is increased and wrinkles are smoothed out of the fabric. Preferably, fabric weights do not visibly damage the fabric at the point of attachment. Likewise, the fabric weights should not leave visible indentations on the fabric at the point of attachment. Some nonlimiting design elements that contribute to preventing indentations and damage include padding or cushioning at the pressure points of the weights.

Since wrinkles differ in difficulty of removal, preferably fabric weights have different masses. The difficulty of wrinkle removal is dependent on fabric type, weight, and depth of the wrinkle. For heavier fabrics, fabric weights with higher masses are applied. When wrinkles are deeper and sharper, heavier weights are applied. It is also preferably that fabric weights are available in different masses since fabric weights with lower masses are more suitable for light fabric weaves (e.g. linen) and loose fabric weaves (e.g. knits). It is even more preferable that the mass of the fabric weights be adjustable by the consumer. It is preferable to use lighter fabric weights on lighter fabrics and knit fabrics to avoid stretching such fabrics. Fabric weights typically have a static or adjustable mass equal to or greater than about 5 g, preferably greater than about 10 g, more preferably equal to or greater than about 50 g, and even more preferably greater than about 100 g and typically equal to or less than about 2300 g, preferably less than about 1800 g, more preferably less than 1100 g and even more preferably less than about 908 g. While heavier fabric weights are preferably for heavier weigth items, for ease of travel and portability, lighter weights are generally preferred.

Preferably, the fabric weights may comprise inflatable devices that may be filled with water at a destination and attached to the fabric to provide the desired weight. After use, the water may then be drained and the weight deflated to ease packing and eliminate unnecessary weight from items packed. Alternatively, the protective enclosure or pouch of the kits of the present invention can also have means for attaching to the fabrics such that the pouch itself serves as a fabric weight. Similarly, it is anticipated that the various accessories that are described hereinafter may be provided with means for attaching each to fabrics so that they may serve as a fabric weight in addition to their stated primary function.

Fabric weights should distribute force evenly over the surface where it is desired to apply wrinkle control. Therefore, it is desirable that the point of attachment of the fabric weight varies in length such that the length of the point of attachment can be suitably matched to the width of the fabric surface over which the force is applied. It is also preferably that the force of the weight be distributed evenly over the entire length of the attachment except in cases where wrinkling of the fabric is distributed unevenly over the surface the weight will be attached to or the surface contains uneven distribution of challenge areas then it is preferably to be able to adjust the force over the length of the attachment to distribute the greatest force where the most wrinkles appear or the most tenacious wrinkles appear or the over the area where the challenge area exists. Typically, the length of the point of attachment of the fabric weight is equal to or greater than about 1.25 cm, and preferably equal to or greater than about 2.54 cm, and typically equal to or less than about 185 cm, preferably equal to or less than about 155 cm, and most preferably equal to or less than less than about 122 cm. For fabric surfaces with a greater width, e.g. curtains, long fabric weights are preferred. For fabric surfaces with shorter widths, e.g. a seam, shorter fabric weights are preferred. Most preferably, the length of the fabric weight is adjustable.

It is preferred for fabrics weights to be reversibly attachable to fabrics. A preferred, but nonlimiting method of achieving a reversible point of attachment on the fabric weight is to incorporate opposing surfaces that accommodate insertion of fabric between the surfaces and exert force against each other. Spring loading of the surfaces is a nonlimiting approach to achieving reversible attachment. The opposing force is preferably strong enough to hold the weight onto the fabric, but preferably not so strong as to leave visible indentations or damage on the fabrics. The opposing forces are preferably balanced vs the mass of the fabric weight such that the fabric weight will not slip off the fabric. Preferably, the spring loading of the fabric weight is adjustable to avoid leaving an indentation in fabrics, while still achieving the appropriate level of normal force to balance the mass of the fabric weight to keep the fabric weight on the fabric until wrinkles are removed.

(b) Mini-Iron

While the wrinkle control composition together with fabric manipulation generally produces a desirable appearance, there are portions of fabrics known as the challenge areas that may still require a higher level of work, pressure, and even heat to achieve the appearance that some consumers desire. To achieve the desired finished look on fabrics in these challenge areas some consumers will continue to iron these areas. Therefore, a mini-iron that can operate independent of an ironing board reduces the work associated with ironing small portions of fabric is a desirable accessory of the kits of the present invention.

A preferred mini-iron essentially provides a self-contained source of counter pressure to eliminate the need for an ironing board. Optionally, but preferably, the mini-iron also provides a source of heat. When the mini-iron provides heat, it is preferable for the device to incorporate a method of controlling the temperature delivered so that this can be adjusted depending on the fabric to be treated to increase the efficacy of the heat and to prevent damage. A non-limiting approach to designing self-contained counter pressure into the mini-iron is to incorporate two surfaces that provide counter pressure. Counter pressure between the two surfaces is preferably reversibly applied after inserting the fabric between the surfaces. When the mini-iron provides heat, it is preferably that the heat source is limited to the surfaces that will contact the fabric and preferable that all other areas of the mini-iron are insulated from heat to prevent accidental bums. When the surface of the mini-iron contacting fabric is heated, it is preferably to provide heat via electrical power, but other sources of power are acceptable for the present invention. It is acceptable for the heating element of the mini-iron to be internal or external.

A preferred mini-iron will also serve as an applicator, applying composition to the fabric during the smoothing operation. When the mini-iron is designed to deliver said composition as well as provide smoothing, it is preferable that the mini-iron be designed to deliver composition at variable levels.

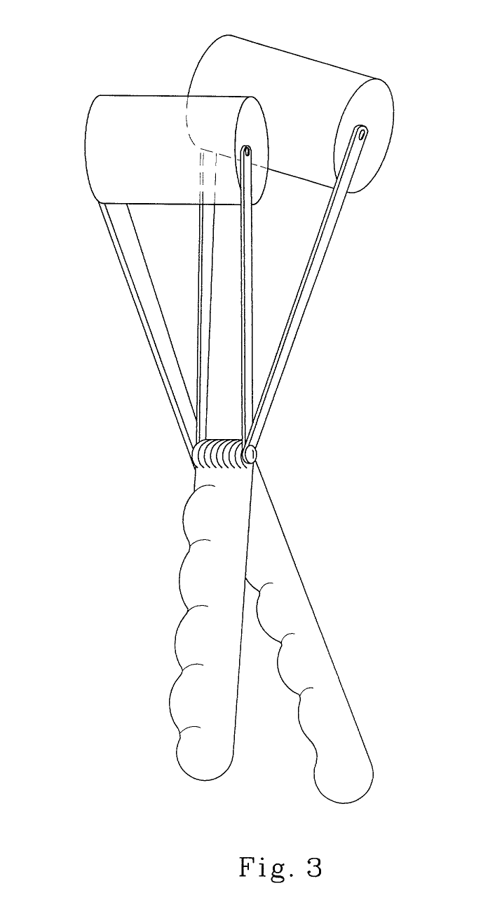

The pressure delivered by the mini-iron to the fabric should be an effective level to improve the smooth appearance of the area contacted. Preferably the level of pressure is also low enough to allow the fabric to be passed through the pressure point to facilitate removal of wrinkles over a larger surface. A nonlimiting approach to allow easy passage of the fabric through the pressure point is design at least one of the surfaces of the mini-iron such that a cross-section through the volume of that surface describes a circle with the volume preferably in the shape of a cylinder or sphere. Preferably, the mini-iron will not cause visible damage to fabrics and more preferably, causes no fabric damage. Preferably very little to no manual force is necessary to apply the appropriate degree of pressure to the mini-iron to remove wrinkles from fabrics. Preferably the surfaces of the mini-iron do not stick to treated or untreated fabrics. Typically, the mini-iron should weigh equal to or less than about 2000 g, preferably less than about 1000 g, more preferably less than about 500 g, even more preferably less than about 250 g, still more preferably less than about 100 g and yet still more preferably less than about 50 g. The surface of the mini-iron that contacts the fabric should project a line or surface that is typically equal to or less than about 20.54 cm long and preferably equal to or less than about 12.7 cm long. A nonlimiting example of a mini-iron is depicted in FIG. 3.

(c) Portable Mats

A portable mat is another optional accessory that is useful to prevent deposition of the wrinkle control composition on unintended surfaces. The mats provide a surface on which the user can manipulate and smooth treated fabrics.

Often it is desired to spread fabrics over a horizontal or nearly horizontal surface and then manipulate wrinkles out of the surface of the fabric by smoothing the fabric with their hands or an implement. In some cases, this is disagreeable, because deposition on unintended surfaces can result in staining or damage to the unintended surface. Also, when deposition of the said composition occurs on unintended surfaces, this generates work to clean up deposition of the said composition on the unintended surfaces. In other cases, there is insufficient space to perform the smoothing operation. In yet other situations, a horizontal surface may exist, but the surface may not be smooth enough or regular enough to facilitate the smoothing operation. Portable mats can be used as a covering for surfaces to protect from unintended deposition of the said composition. Further, portable mats can provide extra space for the smoothing operation when space available is limited such as by bridging a gap between two smaller surfaces. A portable mat can also be placed over an essentially horizontal surface that is not suitable for the smoothing operation because of its inherent roughness or irregularity in order to convert it surface suitable for the smoothing operation.

The portable surface can have a variety of attributes depending on the particular purpose for which the portable surface will be used. It is desirable, for some aspects of the present invention, for the portable surface to be absorbent. Absorbent portable mats very effectively capture composition that is not captured by the surface of the fabric. Absorbent portable mats can also aid in fabric drying. Since the composition is essentially water, it may be desirable for the portable mat to be disposable, particularly where the mat is use to capturing composition that misses the surface of the fabric. Aqueous composition captured within an absorbent portable surface can lead to microbial contamination and as such disposability will minimize the problems associated with microbial contamination. When risk of microbial contamination is a concern, it is preferable to apply an anti-microbial compound to the portable mat surface. Disposable mats can also aid with travel and portability as they may be discarded at any point during travel. At other times, it is desirable for the portable surface to be non-disposable. A non-disposable portable surface is favored by users who wish to reuse the portable surface indefinitely. Non-disposable portable mats are also preferred when it is desirable to reduce the load of disposable materials into the environment. When the portable surface is non-disposable, it is preferred for the portable to be very easily cleaned perhaps for example, by cleaning in a washing machine or wiping clean.

The surface of the portable mat that will be used for smoothing is preferably regular and smooth since irregularities will be transferred to the fabrics during the smoothing operation, thereby reducing the performance of the wrinkle control composition. The surface of the portable mat that contacts the fabric should also have the capacity to keep the fabric from slipping during the smoothing operation. However, contact between the mat and the fabric should not inhibit the rearrangement of the fabric or movements necessary to smooth the fabric. This can be achieved by using materials that grip fabrics lightly. Such materials include, but are not limited to materials with a nap, materials having a coefficient of friction that is large enough that the mat surface prevents fabrics from slipping off the surface during treatment, yet low enough so that an uncomfortable level of drag is not encountered during the smoothing operation.

Preferably, the portable mats will be collapsible or compressible for storage and packing. Preferred ways to compress the portable mat include rolling and folding, and the mat will preferably have closures to hold the mat in its compressed/collapsed condition. It is preferred that when portable mats are decompressed that these maintain a smooth surface on the surface where the garment will be place to prevent transfer of irregularities, such as wrinkles from the portable surface to the fabric. It is optional, but preferred for portable mats to have a handle for ease of transport or storage upon a suspensive point. Where the portable mat is compressible, and provides a moisture barrier, it is anticipated that this portable mat may also serve as the protective enclosure for the kits of the present invention. Alternatively, a portable mat that can be rolled and secured will also provide an enclosure for treated fabrics that will protect them from re-wrinkling.

In aspects of the present invention wherein the portable surface is used for ironing, it is preferred that the portable surface be less flexible and in some cases inflexible. When the portable surface is used for ironing, it is preferred that the surface which is exposed to heat is heat resistant such that it will not substantially deform over the acceptable lifetime of the portable surface due to the application of heat.

A variety of materials are suitable for fashioning portable mats and some nonlimiting choices include, fibrous materials, non-fibrous materials, plastics, synthetic materials, natural materials, wood, metal, ceramics, wovens, non-wovens as well as blends and composites of a variety of materials. It is preferably for portable mats to be lightweight. Portable mats typically comprise at least one layer, but it is suitable and in cases where it is desirable for the various surfaces of the portable surface to have multiple properties, it is preferred for the portable surface to comprise multiple layers. Typically, the length of a portable mat surface is between about 15 cm and about 305 cm, the width of a portable mat is between about 15 cm and about 305 cm and the height is between about 0.15 cm and about 13 cm. The particular dimensions of the mat will be determined based upon the size and shape of the fabric to be treated.

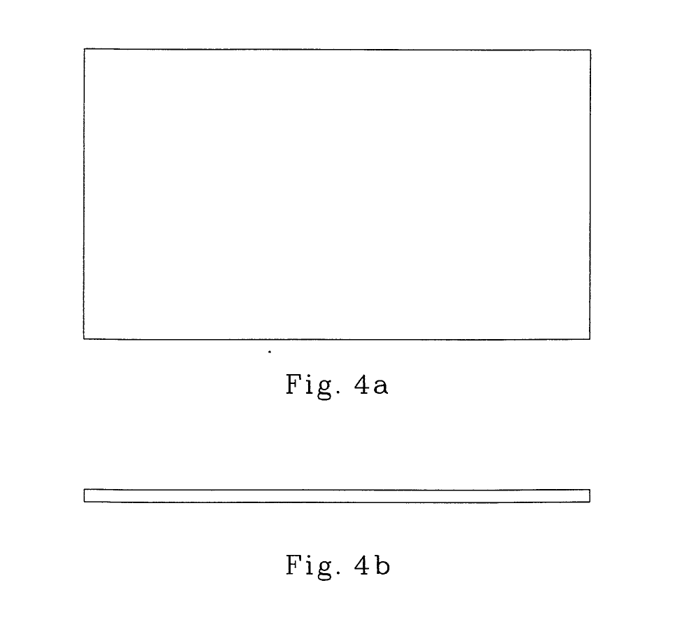

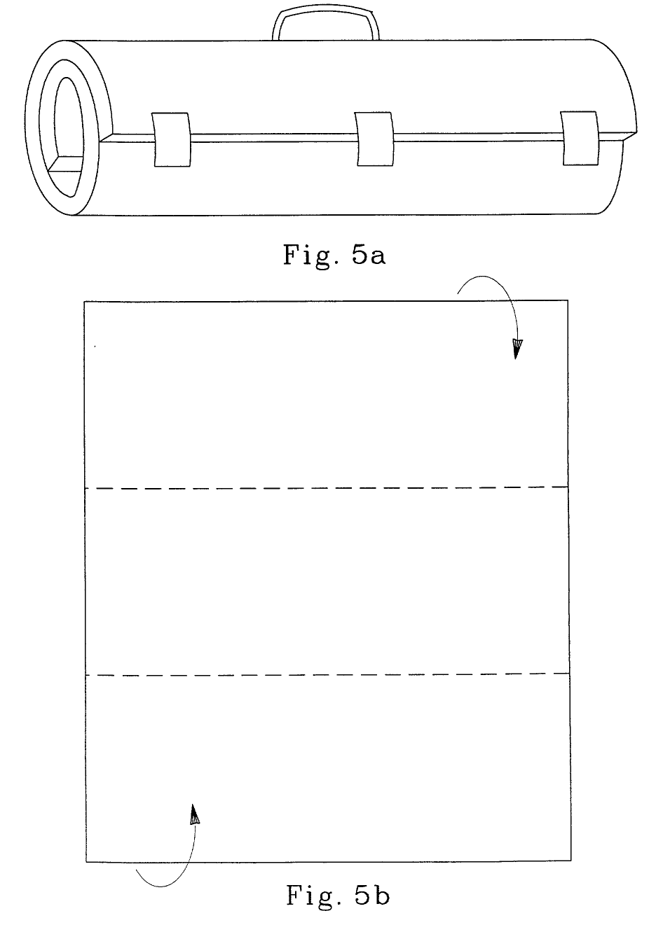

Portable mats are constructed using a variety of techniques including, but not limited to chemical bonding, thermal bonding, mechanical bonding, sewing, stapling, and weaving. When the portable surface is water absorbant, it is preferable to impregnate absorbant layers with a substance to prevent microbial growth. Items that may be used as a portable mat accessory in the kits of the present invention include towels, bed linens, table linens, rugs, mats, cardboard, paper. Examples of portable mats are depicted in FIGS. 4a, 4b, 5a, and 5b.

(d) Hand Articles

The term hand article refers to a covering for the part of the anatomy, preferably the hand or a portion of the hand such as a finger or a thumb, but such articles may be worn and/or adapted for other portions or extensions of the anatomy. The hand article can serve a multitude of purposes. Hand articles can protect the skin from contact with the composition especially during and/or after application to the fabric. Hand articles can also aid as a smoothing device by reducing the coefficient of friction between the fabric and the smoothing device, and thereby reduce the amount of pressure required by the consumer to smooth the fabrics. Further, the protection afforded by the hand article encourages the consumer to feel comfortable in applying firm pressure to the treated fabric, thus contributes to a more effective wrinkle controlling effect.

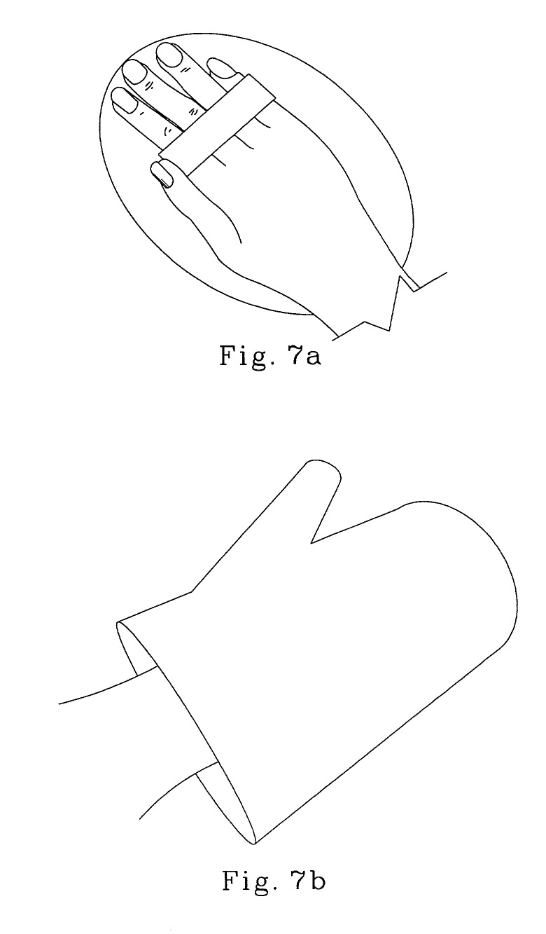

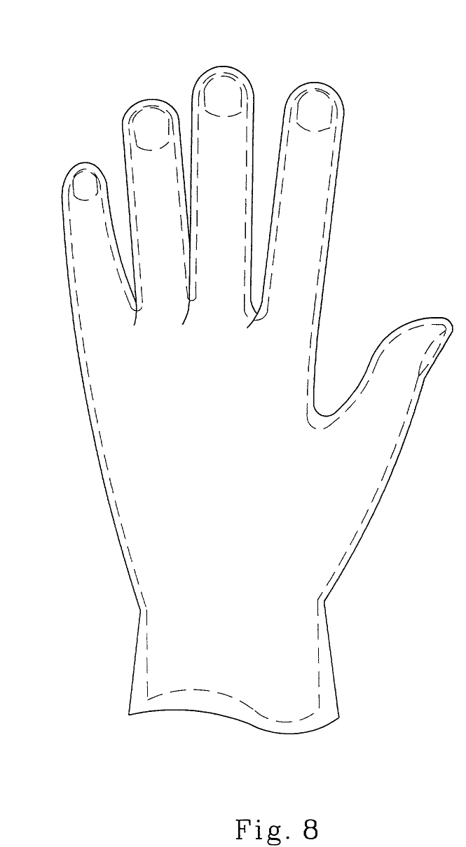

Suitable hand articles can have a plurality of designs. For instance, hand articles may be as simple as a single pad together with a strap or handle by which to hold the padas shown in FIG. 7a. Hand articles may also include insulated mitts having multiple surfaces that are joined together to form a cavity between surfaces for receiving the consumer's hand as shown in FIGS. 7b and 8. For objects that comprise multiple surfaces, each surface may have different physical characteristics to achieve different purposes. Some nonlimiting examples include, means to facilitate the spearding of the composition, means to aid in absorbing aqueous compositions and/or a coefficient of friction that is optimized to reduce work involved in pulling the object across treated fabric surfaces and/or to reduce damage to the fabric surface during the smoothing operation. Hand articles can leave fingers unseparated or provide separation for one or more of the fingers such as with a glove.

Hand articles can be disposable or non-disposable to suit the needs and lifestyles of consumers. For instance, some consumers may wish to use non-disposable hand articles to avoid loading the environment with waste materials. Other consumers may prefer disposable hand articles due to convenience and to avoid drying and storage necessitated by more permanent items. For some aspects of the present invention, it is preferable that the hand article is flexible enough such that the user can perform a variety of other functions in addition to smoothing while wearing the hand article, including, but not limited to: applying composition and arranging fabrics. This feature is useful to save time when the user does not have to continually remove the hand article and reinsert the anatomy.

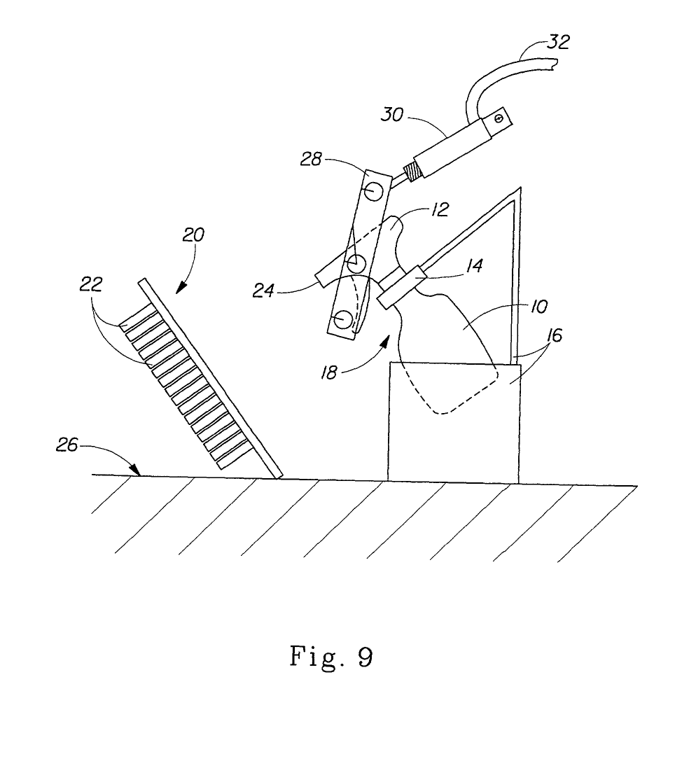

For other aspects of the present invention, it is preferable for the hand article to be less flexible and even rigid. Rigidity is preferable when it is desired to enhance pressure applied by hand through the use of a rigid surface. It is also preferable to use a semi-rigid or inflexible hand article when the hand article will be of the applicator type as disclosed below, but also have handle. When hand articles are absorbant, it is optional, but highly preferable to include a substance to prevent microbial growth. Some non-limiting examples of hand articles are depicted in FIGS. 9, 10, and 11. Nonlimiting examples of hand articles include commercially available gloves such as Co-Polymer™, LPE Latex, Satin Plus® Latex, PFE Latex, all from SafeSkin®.

(e) Combination of Accessories for Use with Aqueous Wrinkle-Control Compositions Combining accessories for use with aqueous wrinkle control compositions is acceptable for the present invention.

D. Optional Re-Fill Containers

Re-fill containers are suitable accessories for use in the kits of the present invention. Re-fill containers provide a way to easily store and transport additional volumes of a given product or multiple types of fabric care compositions. Re-fill containers are also preferred for use in conjunction with smaller article containers because such smaller containers are more quickly depleted tending to encourage under usage if additional volume of the composition is not available.

An acceptable re-fill container is of the type described above as an element of the articles of the present invention, either with or without a spray dispenser for proviging a uniform spray pattern. Preferred re-fill containers should support ease of production and when the connection for the cap or lid is of the same type as the connection for the dispenser, it supports ease of use for the user. Preferably, the re-fill containers should be disposable making travel and portability easier since they may be discarded before returning home. Preferably, the re-fill container will resist damage that might otherwise result in the premature release of the aqueous composition. Likewise, it is preferred that the re-fill container will have structural support at the opening where composition is poured out to prevent unintended spillage during transfer of the composition. Some nonlimiting examples of re-fill containers include the FIT® container and lid available from Owens-Brockway, and offered by The Procter & Gamble Company together with the FIT® composition, a triangular shaped 8 oz bottle and cap available from TricorBraun™ that is offered with the Juniper Breeze Body Splash from Bath and Body Works, and flexible refill packs such as StandPAK®, Kap-PAK®, SealPAK®, ShakerPAK®, all available from KAPAK® Corporation and the item offered together with ATO Care Spray offered by the Lion Corporation.

The containers of the articles and kits of the present invention may also be used to manipulate fabrics after treatment with the fabric care composition. As noted herein, fabrics treated with an aqueous wrinkle control composition should be physically manipulated to remove existing wrinkles. Containers with flat and smooth rounded surfaces may be used as rolling pin to eliminate existing wrinkles from the fabrics.

E. Optional Identifying Markings

Optionally, the articles, kits, and accessories described herein may be linked with indentifiable markings, such as a recognizable image or design element that may be used by the consumer to associate said aqueous compositions and accessories, instructions, and packaging together. The markings can also be used to indicate the manufacturer of the implements, articles, devices, compositions, etc. Recognizable images and design elements include, but are not limited to trade dress, product names, trade names, color, color schemes, shapes, label designs, etc. Preferably when the articles, and accessories have a recognizable image, this recognizable image matches the recognizable image of the wrinkle control composition. Use of these markings is desirable to help associate the specific implements, etc. to the specific wrinkle control compositions, that are often separated after purchase, even if they are together in a package as a single artcle when sold. It is important to provide the consumer with confidence that the consumer is using the appropriate combination of, e.g., device and composition.

F. Optional Instructions

Travel accessories are useful for improving the convenience and portability of aqueous composition on a variety of trips. Trips can be long trips, including at least one night away from the domicile, or short trips wherein the user does not stay away from the domicile for any nights. Long trips include trips for pleasure and necessity, including but not limited to hospital stays, vacations, business trips, visits with relatives. Short trips also include trips for pleasure and necessity including but not limited to day trips, trips to museums and places of entertainment, trips to physical fitness sites, work place, errands, social engagements, transporting children, shopping trips, etc. Users are instructed to take aqueous control compositions on a variety of long and short trips. Users are instructed to transport and store aqueous compositions in places where the aqueous composition would be convenient and useful during trips away from the domicile. A nonlimiting list of places to transport and store aqueous compositions on long and short trips includes car, glove compartment, gym locker, tote bags, purse, gym bag, luggage, backpack, desk, etc.

1. Instructions for Using Containers and Dispensers for Travel and Portability

Typically, it is very difficult to affordably manufacture containers and dispensers that have reversible connections that never leak. Therefore, when the dispenser is removeable it is optional, but preferably to remove the dispenser prior to travel to prevent leakage. The dispenser is replaced with a tightly fitting cap or lid to prevent leakage during travel. It is especially preferable to remove the dispenser prior to traveling by air or to a higher altitude where a change in air pressure is likely. The user is instructed to clean the stem of the dispenser prior to packing it away to prevent unintentional contamination of surfaces with aqueous composition. The dispenser may then be packed for travel and replaced when the user reaches their destination. Optionally, but preferably, the dispenser and the capped container are packed close together so these can readily be rejoined. Optionally, but preferably the dispenser and the container are packed together into a travel pouch.

In use, the dispenser should be pointed towards the fabric and product should be dispensed in a sweeping motion to provide best performance and reduce the potential for staining and drying time. When traveling, users are instructed to treat clothes with aqueous compositions as the clothes are unpacked, since it takes time for aqueous compositions to dry, it is useful to treat these ahead of time.

2. Instructions for Using Pouches for Travel and Portability

When it is desired to transport aqueous control composition, it is often useful to have a travel pouch in which to keep the articles of the present invention, optional accessories, and re-fill containers together in one place so that these can be easily found during transportation and used together. The user chooses items of highest need for the particular trip and place these in the travel pouch.

Some specific nonlimiting examples are provided for clarity. When a trip is made to a workout facility, a gym bag, tote, backpack are all acceptable nonlimiting examples of travel pouches useful for the present invention. The user packs necessary items for the gym, such as workout clothes, workout shoes, personal care items for use after the workout, e.g. personal cleanser, deodorant, shampoo, etc., a change of clothes if workout clothes are worn to the gym, wrinkle control or odor control composition in a container with a spray dispenser or a hand article applicator. Wrinkle control composition is used, for example, when the change of clothes is taken from the gym bag and hung in the locker, so these will be dewrinkled when the user is finished with the workout. Alternately, the user can treat clothes after the workout and use a hand or hair dryer to accelerate the drying process. When the trip is to transport children to the soccer field, a tote bag is a nonlimiting example of a useful travel pouch, the user packs soccer clothes for the soccer players or a change of clothes if soccer clothes are worn to the field; snacks, drinks, tissues, first aid items or first aid kit, wet wipes or wet wash cloth along with wrinkle control composition in a container with a spray dispenser. The wrinkle control composition is used, for instance, prior to having children change into clean clothes. When the trip is to leave town, a piece of luggage or a pouch for toiletries are nonlimiting examples of travel pouches useful for the present invention. The user packs toiletries, personal care and cleansing items, personal papers for travel, etc. and various aqueous compositions in a portable container with a spray dispenser, a re-fill, one or more compressible travel hangers, a clothesline, and a portable surface. When the trip is to a social event after work, a purse or tote are nonlimiting examples of useful travel pouches. For this trip the user packs a change of clothes suitable for the social event, personal care products such as make-up, cologne, hair care products, jewelry, deodorant, breath mints, wrinkle control composition in a portable container together with a spray dispenser.

When general aqueous compositions for treating fabrics and trigger sprayer are taken on a trip in a travel pouch, clothes or fabrics are treated at typically least about 3 minutes before use, preferably at least about 5 minutes before use, more preferably at least about 15 minutes before use, most preferably at least about 20 minutes before use. When fabrics are treated only a short time before use and do not have adequate time to dry, a hand dryer or hair dryer can be used to reduce drying times.

3. Instructions for Using Re-Fills

Re-fills are useful for trips, because these extended the amount of composition available for use. A nonlimiting list of places to transport, store, and pack re-fills during trips away from the domicile is given under heading III above.

4. Instructions for Using Aqueous Compositions for Wrinkle Control

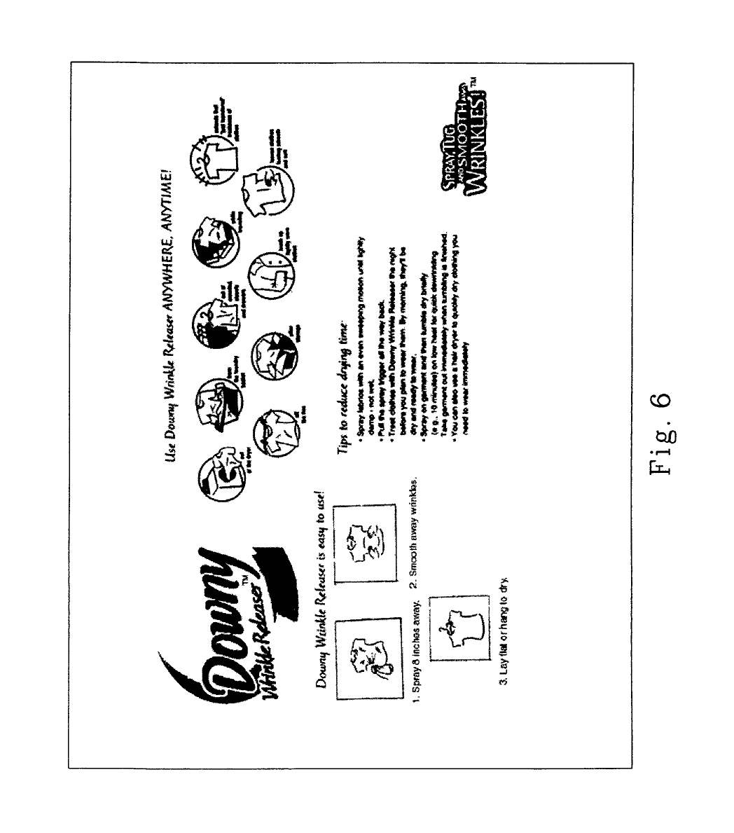

Instructions for using aqueous compositons for wrinkle control are disclosed in detail in Ser. No. 09/805,099; Frankenbach et al., filed Mar. 13, 2001 which are incorporated herein by reference. Non-limiting examples of instructions for using aqueous wrinkle control compositions are depicted in FIG. 6.

5. Instructions for Using Aqueous Compositions for Odor Control

U.S. Pat. No. 5,968,404; Toan et al., granted Oct. 19, 1999 Column 44 Line 32 to Column 45 Line 11, Column 45 Line 58 to Column 46 Line 31. References to wrinkle control agents and wrinkle control methods in the above citation refer to nonlimiting examples of odor control formulations containing wrinkle actives and while these are not intended to be nonlimiting examples of instructions or compositions for odor control.

6. Instructions for Using Travel and Portability Accessories for Use with Specific Compositions

a. General Fabric Treatment.

When aqueous compositions will be used for treating fabrics, typically the composition must be dispensed onto the fabrics and often the fabrics become damp as a result of depositing a certain amount of water along with the efficacious dose of active. The need to dispense composition onto fabric makes specialized hangers and compressible devices for suspending the fabrics quite useful as these accessories aid in exposing a greater amount maximum of fabric surface. Since fabric must also dry, the hangers and suspensive accessories are also useful for air drying fabrics. When it is desired to dry fabrics even faster, air blowers are useful.

(i) Instructions for Using Specialized Hangers and Compressible Suspensive Devices

Hanger and suspending accessories that are compressible and/or adjustable should be configured to not only expose an increased amount of fabric surface area but should also retain the fabric in a configuration as near as possible to the final desired configuration of the fabric. While it is acceptable to suspend the hanger or suspensive device either before or after the fabric is arranged upon it, it is preferable to apply said composition after the fabric is arranged on the hanger or suspensive device and suspended. When elements are available to fix fabrics in place (e.g. clips) upon the hanger or suspensive device and using these is helpful to either, suspend the fabric, expose the maximum surface area of the fabric, or to retain the fabric in a desired configuration, these are optionally used while the fabric is arranged on the hanger or suspensive device. When the fabric itself comprises fastening elements (e.g. buttons, clasps, ties, snaps, etc.) and fastening these help expose the maximum amount of fabric surface area or retain the fabric in the desired configuration, these are optionally fastened as the fabric is arranged on the hanger or suspensive device. After fabric is arranged in the desired configuration on the hanger or suspensive device, aqueous composition is applied composition is applied. Preferably, fabric is left on the hanger or suspensive device until dry. After removing fabrics from the fabric framework, the fabric framework is compressed for storage when so designed. It is also acceptable to store the fabric framework by hanging in a closet, on a clothes rack, door knob, or other convenient location.

(ii) Instructions for Using Air Blowers

When air blowers are used to reduce drying times, it is anticipated that the fabrics will be manipulates both before and during introduction of an air stream. It is acceptable to direct the air stream to any part of the fabric that will facilitate drying. It is acceptable to hold and/or manipulate fabrics while these are in the air stream or to manipulate fabrics prior to exposure to the air stream. When fabrics are manipulated prior to exposure to the air stream, it is preferred to either hang or spread fabrics in a manner that preserves the preferred wrinkle free or wrinkle reduced configuration during the drying process. However, since it is no longer possible to manipulate wrinkles out of the fabrics after the fabrics are dry, when wrinkles will be removed, it is highly preferable to reduce or remove wrinkles to the desired level prior to allowing the fabric to become dry.

It is acceptable to use a cold, cool, warm, or hot air stream to dry fabrics. Although all temperatures are acceptable, it is preferable to check the fabric manufacturer's suggestions for drying temperatures and follow these suggestions to prevent fabric damage. When it is desired to dry multiple fabrics or large fabrics it is optional, but preferred to use a device that generates a large air stream. For instance, if draperies are treated and it is desired to dry these more quickly, a large house fan is useful for achieving faster drying. When only one or a few fabrics must be dried more quickly that is possible by hanging in the air, it is acceptable to use a hair dryer to achieve faster drying.

2. Instructions for Using Accessories for Use with Wrinkle Control Compositions

(i) Using Fabric Weights with Aqueous Wrinkle Control Composition

Typically fabrics are suspended in a substantially vertical position prior to using fabric weights, since fabric weights are intended to increase the force of gravity on the fabric surface. Fabric weights can be attached to fabrics before or after treating the fabric with wrinkle control composition. However, it is preferably to treat the fabric with said composition prior to attaching fabric weights to fabrics. The amount of said composition applied, should be consistent with levels recommended for the particular type of fabric (composition, weight) and the degree of the wrinkling.

Following treatment of the fabric, weights are selected in the length and mass appropriate for the type of wrinkle and the type of the fabric. Preferably the length of the weight will span the width of the wrinkled surface that requires weighting for wrinkle removal. When wrinkles are deep and sharp, or the weight will be applied to challenge areas, especially those that are deeply wrinkled, weights of a greater mass are preferred. When wrinkles are not as deep or sharp, resembling more bumpiness or rumples, it is preferred to apply weights of a lighter mass. Preferably weights with an effective mass for removing wrinkles will be used, but weights that are heavy enough to cause stretching or alter the natural shape of the garment will be avoided. For treating fabric surfaces of smaller lengths, e.g. pockets, plackets, pant legs (since the weight is typically applied to the bottom of the pant leg) weights of a smaller length should be chosen. For treating fabric surfaces of longer widths weights with longer lengths are also used. Preferably, the length of the weight will span the width of a wrinkle region.

Preferably fabric weights are left on the fabrics for an effective amount of time to reduce or remove wrinkles, but a short enough amount of time to prevent the fabric from stretching or loosing shape.

(ii) Instruction for Using the Mini-Iron with Aqueous Wrinkle-Control Composition

Fabrics are smoothed with the mini-iron either before or after treatment with wrinkle control composition, but preferably the smoothing with the mini-iron follows treatment with the said composition. Fabrics are treated with wrinkle composition, manipulated and inspected for outstanding wrinkles, especially in challenge areas, if wrinkles remain, optionally, the mini-iron is used to remove these. Optionally, the sites that require additional smoothing with the mini-iron are treated again with said composition. Another optional approach to smoothing fabrics with the mini-iron has said composition applied from the mini-iron and optionally concurrent with the smoothing operation. When said composition is used in combination with the mini-iron an effective level of composition is applied to provide wrinkle control together with the use of the mini-iron. Areas that are deeply and/or sharply wrinkled require more of the said composition than areas that are lightly and/or less sharply wrinkled. Whenever and however composition is applied, it is preferably applied in a uniform manner. Preferably, the consumer will reapply wrinkle control composition to the part of the garment that is passed through the mini-iron prior to using the mini-iron on this area. This procedure is optionally repeated until the area of the fabric has the desired level of smoothness. Also, optionally, the fabric is held between the, preferably heated, pressure point of the mini-iron for longer periods of time to help ease difficult wrinkles out of the fabric. For some aspects of the present invention it is acceptable for the consumer to use the mini-iron independent of the wrinkle control composition.

(iii) Instruction for Using Portable Mats with Aqueous Wrinkle Control Composition

If the portable surface is compressed for storage, it is spread flat prior to use. If the portable surface has residual wrinkling from compression during storage, preferably the residual wrinkles are smooth out of the surface prior to use to prevent transfer to fabrics. The portable surface should be clean prior to use. If the portable surface has dirt or particles on the surface, these should be removed prior to use so that these will not be transferred to the fabrics. After spreading the portable surface, a fabric is arranged on the portable surface so as to maximize the amount of surface area available for application of the said composition and/or to place the fabric in the desired final configuration. Optionally, but preferably, the fabric is treated with said composition after being spread on the portable surface. Following application of the treatment the fabric is manipulated to remove or reduce wrinkles. If it is desired to treat the opposite side of the fabric, the fabric is turned over and spread out smoothly again, to expose the maximum amount of fabric surface and/or arrange the fabric in the desired final configuration. Said composition is applied to the opposite side of the fabric. It is acceptable to allow fabrics to dry on the portable surface. When the portable surface is used for more than one fabric, fabrics are moved to another location to be either suspended or spread out for drying. When the fabrics are moved to another location for drying, it is preferable that the smooth, wrinkle free configuration is retained when the fabric is moved.

(iv) Instructions for Using Hand Articles with Aqueous Wrinkle-Control Compositions

Hand articles are acceptable for use with fabrics that are both suspended or spread. Hand articles are useful both for arranging the fabric prior to treatment and then manipulating fabrics post-treatment to remove and/or reduce wrinkles. To use, a portion or extension of the anatomy, preferably the hand, is reversibly attached to or inserted into the hand article. Optionally, but preferably, the hand article remains on the hand during the entire treatment process. When it is desired to use both hand and/or more than one part of the anatomy to manipulate wrinkles out of fabrics, it is acceptable and often preferable to use more than one hand article to keep all parts of the anatomy isolated from contact with the said composition and/or fabrics treated with said compostion.

(v) Instructions for Creating Kits

Instructions for creating kits include recommendations for where to obtain elements. Since users would not always know where to obtain every item for a kit and further, the user would not typically be the most knowledgeable about where to obtain the most effective elements, the user would be instructed where to obtain effective elements. Users would also be instructed on how to create a variety of kits tailored for various uses. Some nonlimiting instructions for creating kits for various uses are disclosed in section F. Optional Instructions, part 2. Instructions for Using Pouches for Travel and Portability, above

### III. Test Methods

A. Patternator Test

The Patternator Test method is used to evaluate a spray pattern of a spray dispenser. The Patternator Test generates data to quantify a spray pattern in terms of volume of liquid per unit of surface area covered by the spray. A standard deviation is also calculated from this test method.

An apparatus used to perform the Patternator Test method is shown in FIG. 1. The Patternator Test is carried out according to the following method.

A wrinkle control composition is placed in a plastic bottle 10 with a spray head 12 attached thereto to form a spray dispenser 18. The spray head 12 of the plastic bottle 10 is placed in a vise-like clamp 14 and attached to the patternator apparatus 16.

The spray dispenser 18 is aimed towards a two-dimensional 17×17 tube array 20 of graduated 14 mL conical tubes 22 (289 tubes total) with a 1.50 cm diameter at the top of each tube 22 and 1 mL graduation marks on each tube 22. There are 10 tubes 22 per 15.2 cm length in both the horizontal and vertical direction on the tube array 20. The nozzle 24 of the spray dispenser 18 is positioned 6 inches (2.36 cm) from the tube array 20 and aimed toward the center of the tube array 20, such that when the wrinkle control composition is sprayed towards the tube array 20, the tubes 22 will collect the composition. The spray dispenser 18 is aimed at the tube array 20 such that the spray stream is perpendicular to the tube array 20 and the tube array 20 is at a 45° angle to a horizontal surface 26. Each tube 22 corresponds to a surface area element of about 1.77 cm².

An actuator 28 is used to trigger the spray dispenser 18 at a controlled pressure. The actuation pressure is chosen based on measuring the sprayer piston cylinder pressure developed as consumers used typical examples of spray dispensers. The actuation pressure is from about 40 to about 50 pounds per square inch (psi). The piston 30 driving the actuator 28 is powered by compressed air fed through a flexible tube 32 connected to the piston 30.

The spray dispenser 18 is triggered by the actuator 28 100 times and the composition dispensed from the 100 sprays is collected by the tubes 22 of the 17×17 tube array 20. After the liquid from 100 sprays is collected, each tube 22 is removed from the tube array 20 and the amount of liquid in each tube 22 is recorded. This data is inputted into a spreadsheet computer program (Microsoft Excel 2000™) which is used to calculate the volume of liquid per unit of surface area and the standard deviation thereof. The results of these data are plotted as a function of volume vs. surface area to create a three-dimensional graph.

B. Staining Test

The Staining Test is carried out by spraying a composition onto a hanging fabric from a selected spray dispenser with a distance of 6 inches between the nozzle of the spray dispenser and the surface of the fabric. The fabric used to assess staining comprises a medium dark color, like green or blue polycotton (Springmaid TREMODE combed broadcloth, polycotton fabric 65% polyester and 35% cotton, any medium dark color, e.g. a nonlimiting example is color# 99555 called kelly green). Each time a dispenser is tested with a wrinkle control composition, ten swatches are sprayed. The number of swatches with a visible stain are tabulated and the number of stains per ten swatches sprayed is reported.

C. Dry Time Test

The Dry Time Test is carried out under conditions where the relative humidity is 20-27 RH at a temperature of 71-73° F. as measured by an Omega CTH100 temperature/relative humidity chart recorder (from Omega Engineering). A composition is dispensed from a spray dispenser onto fabric (Springmaid TREMODE combed combed broadcloth, polycotton fabric 65% polyester and 35% cotton) at a distance of 6 inches between the nozzle of the sprayer and the fabric. The fabric is sprayed while it hangs on a suspending device designed to sit on a typical lab scale (e.g. Mettler PM4000; Mettler PM2000) as it suspends the drying fabric. The suspending device is a T-shaped metal stand that fabric can be clipped onto. The fabric is attached to the suspending device as it is sitting on the scale. After the fabric is attached to the suspending device on the scale, then sprayed as directed above. Immediately, the initial weight of the fabric is noted at time=0 minutes. The weight of the fabric is noted at time=2 minutes, 5 minute, and 10 minutes after spraying. The % change in weight from the initial value is plotted as a function of time. To generate the dry time, for each sprayer type, two sprayers are used and two replicates are done per sprayer. Therefore, for each sprayer, the dry time data is repeated four times. The data is averaged over the four runs for the plot.

D. Spray Diameter Test

The Spray Diameter Test measures the area of fabric that is covered by a wrinkle controlling composition dispensed from a spray dispenser. The Spray Diameter Test can be used to measure the differences between the area of fabric cover by wrinkle controlling compositions having different viscosities.

A dye (Milliken Liquitint Blue) is incorporated into a wrinkle controlling composition to be tested. Using a spray dispenser to spray the dyed wrinkle controlling composition, the composition is sprayed onto a sheet of white paper from a distance of 6 inches. A circle is formed on the white paper by the dyed wrinkle controlling composition sprayed onto the paper. The diameter of the widest portion of the circle is measured.

When the viscosity of the wrinkle controlling composition is too high, the product tends of the product in a smaller area on the fabric tends to lead to staining of the fabric and longer dry times and so is undesirable.

E. Tilt Stability Test

The tilt stability test is used to measure the stability of the articles of the present invention both during end use and as an article is manufactured e.g. stability of packaging during filling, capping, packing and various line operations.

To model the stability of packaging during end use, bottles are filled to capacity with an aqueous composition at room temperature and topped with a preferred dispenser, the trigger sprayer. The triggers sprayers used were those included with the package or the TS800-2E trigger sprayer available from Calmar.

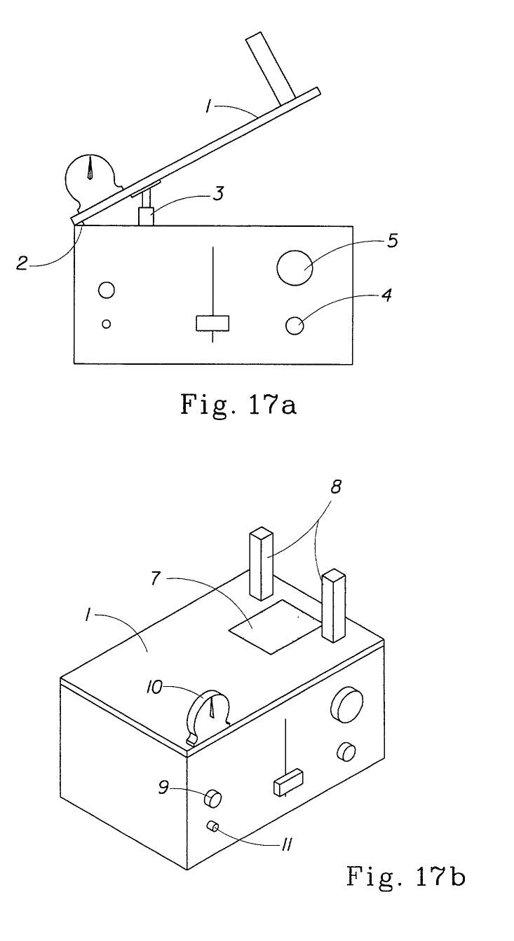

The tilt stability tester illustrated in FIG. 17a, comprises platform 1 attached to the tester at one end by hinge 2. The rise of the platform surface is driven by an air pressurized piston 3. The speed of the rise is controlled by a platform raise motor speed control. The rate of rise is indicated by the pressure gauge (from Ashcroft) and it is set to 10 PSIG which is equivalent to 2 degrees/sec. The rise of the platform is timed to confirm accuracy of the setting. To confirm the maintenance of air pressure during operation a flowmeter, model FM559A from Rexarc was used.

A container prepared for testing is place on a piece of sandpaper 7 attached to the surface of the platform. The sandpaper prevents the bottle from sliding on the platform so that tipping can occur. The container is placed in the beam of the electric eye 8 and the container interrupts the beam. If the container is not opaque enough to interrupt the beam, it should be masked with tape such as masking tape or duct tape. The start button activates the motor to drive the rise of the platform. As the platform rises, the container eventually tips over and the continuity of the beam is resumed. The resumption of the beam shuts off the motor driving the rise of the platform. The angle at which the container tips can then be read from angle finder 10, a Combination Level and Angle Finder available from Alfred Emerson Industries Ltd., Amherstburg, Ontario, Canada.

The tilt angle is measured for three samples of each container in each of the two positions. When the trigger sprayer will not mate with the neck of the container, duct tape is used to secure it into place. This was done to determine which were the most useful sizes and geometries for travel size containers mated with trigger sprayers. Containers were tested with the direction the trigger sprayer parallel to and perpendicular to the electric eye beam. Since users typically exert force on the container parallel to the direction of the trigger sprayer when reaching for and grasping a container, it is believed that this data most closely models this situation.

The following are non-limiting examples of the present invention. All percentages, ratios, and parts herein, in the Specification, Examples, and claims are by weight and are the normal approximations unless otherwise stated and all references are incorporated by reference.

### EXAMPLE I

The following are non-limiting examples of the present invention. All percentages, ratios, and parts herein, in the Specification, Examples, and claims are by weight and are the normal approximations unless otherwise stated and all references are incorporated by reference.

A. The Following are Examples of general aqueous compositions of the
present invention.

| Compound | 1 | 2 | 3 | 4 | 5 |
|---|---|---|---|---|---|
| Water | 100% | Bal. | Bal. | Bal. | Bal. |
| EtOH | 0 | 0 | 0 | 3.0 | 10.0 |
| Perfume | 0 | 0.01-0.04 | 0.01-0.04 | 0.01-0.04 | 0.01-0.04 |
| Proxel ® GXL³ | 0 | 0 | 0.015 | 0.015 | 0.015 |

B. The following are Examples of wrinkle controlling compositions of the
present invention:

| Compound | 1 | 2 | 3 | 4 | 5 |
|---|---|---|---|---|---|
| Water | 100% | Bal. | Bal. | Bal. | Bal. |
| Luviflex Soft¹ | 0 | 0 | 0 | 0.4 | 0.7 |
| DC5247² | 0 | 0 | 0 | 1.5 | 1.5 |
| Perfume | 0 | 0.01-0.04 | 0.01-0.04 | 0.01-0.04 | 0.01-0.04 |
| Proxel ® GXL³ | 0 | 0 | 0.015 | 0.015 | 0.015 |

¹Ethylacrylate methacrylate copolymer, average MW = 250,000 from BASF
²Silicone polyether available from Dow Corning.
³1,2-benzisothioazoline-3-one available from Zeneca.

| Compound | 6 | 7 | 8 | 9 | 10 |
|---|---|---|---|---|---|
| Water | Bal. | Bal. | Bal. | Bal. | Bal. |
| Luviflex | 0.3 | 0.4 | 0 | 0 | 0.3 |
| Soft | | | | | |
| Diahold | 0 | 0 | 0.7 | 0.5 | 0.4 |
| ME ®⁴ | | | | | |
| Silwet ® | 4.0 | 1.5 | 0 | 0 | 1.0 |
| L7001⁵ | | | | | |
| DC190⁶ | 0 | 0 | 1.5 | 2.0 | 0 |
| LaraCare ™ | 0.5 | 0 | 0 | 0 | 0 |
| A200⁷ | | | | | |
| Hydroxy- | 0.3 | 0.3 | 0.3 | 0 | 0.3 |
| propyl-β- | | | | | |
| Cyclodextrin | | | | | |
| Ethanol | 3.0 | 3.0 | 3.0 | 3.0 | 3.0 |
| Proxel ® | 0.015 | 0.015 | 0.015 | 0.015 | 0.015 |
| GXL | | | | | |
| Perfume | 0.01-0.04 | 0.01-0.04 | 0.01-0.04 | 0.01-0.04 | 0.01-0.04 |
| PH | 5-7 | 5-7 | 5-7 | 5-7 | 5-7 |

⁴Copolymer comprising t-butylacrylate, ethylacrylic acid graphted with silicone polydimethylsiloxane macromer.
⁵Pendant copolymer of polydimethylsiloxane and ethylene-oxide/propylene oxide with an average MW = 20,000 and an EO/PO ratio of 60/40 available from CK-Witco.
⁶Pendant copolymer of polydimethylsiloxane and ethylene-oxide/propylene oxide available from Dow Corning
⁷Arabinoglactan polymer available from Larex ®, Inc.

C. The following are aqueous odor control compositions of the
present invention.

| Compound | 1 | 2 | 3 | 4 | 5 |
|---|---|---|---|---|---|
| Water | 100% | Bal. | Bal. | Bal. | Bal. |
| Hydroxypropyl-β- | 0 | 0 | 0.2 | 0 | 0.2 |
| Cyclodextrin | | | | | |
| Methylated-β-Cyclodextrin | 0 | 0 | 0 | 0.2 | 0 |
| Perfume | 0 | 0.02 | 0.015 | 0.015 | 0.02 |

| Compound | 6 | 7 | 8 | 9 | 10 |
|---|---|---|---|---|---|
| Water | 100% | Bal. | Bal. | Bal. | Bal. |
| Hydroxypropyl-β- | 0 | 0 | 0.2 | 0 | 0.2 |
| Cyclodextrin | | | | | |
| Methylated-β-Cyclodextrin | 0 | 0 | 0 | 0.2 | 0 |
| perfume | 0 | 0.02 | 0.015 | 0.015 | 0.02 |
| Proxel GXL | 0 | 0 | 0.015 | 0.015 | 0.1 |
| Kathon CG¹ | 0.003 | 0.003 | 0 | 0 | 0.003 |

¹A mixture of 5-chloro-2-methyl-4-isothiazolin-3-one and about 23% 2-methyl-4-isothiazolin-3-one, a broad spectrum preservative available from Rohm and Haas Company.

| Compound | 11 | 12 | 13 | 14 | 15 |
|---|---|---|---|---|---|
| Water | 100% | Bal. | Bal. | Bal. | Bal. |
| Hydroxypropyl-α- | 0.1 | 0 | 0.11 | 0 | 0 |
| Cyclodextrin | | | | | |
| Hydroxypropyl-β- | 0 | 0 | 0.29 | 0 | 0.15 |
| Cyclodextrin | | | | | |
| Methylated-α-Cyclodextrin | 0 | 0.15 | 0 | 0.2 | 0.23 |
| Methylated-α-Cyclodextrin | 0 | 0 | 0 | 0.2 | 0 |
| Propylene glycol | 0 | 0 | 0.025 | 0 | 0 |
| Zinc chloride | 1.0 | 0 | 0 | 1.5 | 1.0 |
| Perfume | 0.015 | 0.02 | 0.015 | 0.015 | 0.02 |
| Proxel GXL | 0 | 0 | 0.015 | 0.015 | 0.1 |
| Kathon CG¹ | 0.003 | 0.003 | 0 | 0 | 0.003 |

### EXAMPLE II

This Example demonstrates the differences among different spray dispensers in regard to spray pattern distribution. A variety of spray dispeners are evaluated according to the Patternator Test method described hereinbefore in Section III.A. supra.

The following wrinkle controlling composition is used to evaluate the spray pattern of the spray dispensers to be tested:

| Component | Weight of Active |
|---|---|
| Fluid 245¹ | 2.5% |
| Silwet L77² | 2.0% |
| Neodol 23-3³ | 0.5% |
| Stepanol WAC⁴ | 0.1% |
| Perfume | 0-0.04% |
| Preservative | 0-0.13% |
| Tris (hydroxy methyl)amino mentane | 0.57% |
| HCl | 0.05% |
| pH | 8-9 |
| Water | balance |

¹Decamethylcylcopentasiloxane available from Dow Corning.
²Pendant copolymer of polydimethyl siloxane and ethylenoxide with average molecular weight of 600, available from CK-Witco.
³Alkyl ethoxylate surfactant with 12-13 carbons and an average of three ethoxylate groups available from Shell.
⁴Sodium lauryl sulfate available from Stepan.

A variety of spray dispensers are tested according to the Patternator Test. The results of the test are given in terms of a spray pattern having a volume per unit of surface area and standard deviation thereof, and are shown in the following table:

| | | | Standard Deviation in | |
|---|---|---|---|---|
| Sprayer | Volume/Surface Area | | Volume Surface | |
| Mixor¹ 1.00 cc × 0.025 × | 0.087 | ml/inch² | 0.080 | ml/inch² |
| 0.030 | (0.014 | ml/cm²) | (0.0124 | ml/cm²) |
| Mixor² 1.00 cc MP | 0.076 | ml/inch² | 0.056 | ml/inch² |
| | (0.012 | ml/cm²) | (0.0087 | ml/cm²) |
| Calmar TS-800-2G³ | 0.069 | ml/inch² | 0.065 | ml/inch² |
| | (0.011 | ml/cm²) | (0.010 | ml/cm²) |
| T-8500 1 cc Dow | 0.020 | ml/inch² | 0.021 | ml/inch² |
| Shroud⁴ | (0.0031 | ml/cm²) | (0.0033 | ml/cm²) |
| Calmar TS-800-2E⁵ | 0.023 | ml/inch² | 0.016 | ml/inch² |
| | (0.0036 | ml/cm²) | (0.0025 | ml/cm²) |
| Calmar TS-800-2E RO⁶ | 0.017 | ml/inch² | 0.009 | ml/inch² |
| | (0.0026 | ml/cm²) | (0.0014 | ml/cm²) |
| Calmar TS-800-2⁷ | 0.012 | ml/inch² | 0.007 | ml/inch² |
| | (0.0019 | ml/cm²) | (0.0011 | ml/cm²) |

¹Available from Calmar, land length is 0.030, diameter of orifice in the nozzle is 0.025, the nozzle part number is 1PD04105.
²Available from Calmar, land length is 0.020, diameter of the orifice in the nozzle is 0.025, the nozzle part number is 1PD04105.
³Available from Calmar, land length is 0.060, diameter of the orifice is 0.025, the nozzle part number is 7PD04105.
⁴Available from CSI, land length is 0.031, diameter of the orifice is 0.025, and the nozzle part number is 8501.
⁵Available from Calmar, land length is 0.060, diameter of the orifice is 0.025, and the nozzle part number is 7PD04105.
⁶Available from Calmar, specifications equivalent to those in reference 5.
⁷Available from Calmar, land length is 0.040, diameter of the orifice is 0.030, and the nozzle part number is 8PD04105.

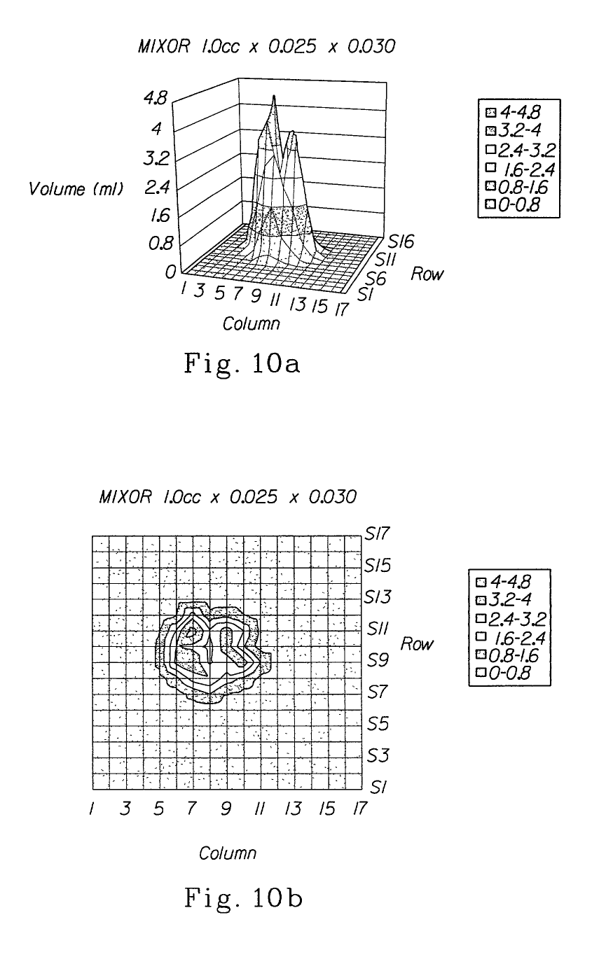

A review of FIGS. 10a through 15b reveals that unacceptable sprayers generally have ‘hot spots’ where a large volume of liquid is being distributed in a small unit of surface area.

### EXAMPLE III

This Example illustrates the need to utilize a spray dispenser which provides a spray pattern as desired in the present invention in order to minimize the potential staining of fabrics treated with a wrinkle controlling composition.

A variety of spray dispensers are evaluated using the Staining Test as described in Section III.B. supra. The following wrinkle controlling composition of the present invention is used to evaluate the affect the spray dispener has on the potential to stain fabrics treated with the wrinkle controlling composition:

| Composition | Active Weight |
|---|---|
| Luviflex Soft¹ | 0.7% |
| Silwet L7001² | 1.5% |
| LaraCare A200³ | 0.5% |
| Hydroxylpropyl-β-cyclodextrin | 0.35% |
| Ethanol | 3.0% |
| Perfume | 0-0.04% |
| Preservative | 0-0.02% |
| PH | 5-6 |
| Water | Balance |

¹Ethylacrylate methacrylic acid copolymer (approximately 250,000 MW) available from BASF.
²Silicone glycol copolymer available from CK-Witco.
³Arabinoglactan polysaccharide (approximately 20,000 MW) available from Larex.

The wrinkle controlling composition is sprayed using a given sprayer according to the Staining Test method. The results of the Staining Test are shown in the following table:

| Sprayer | # Swatches Sprayed | # Swatches Stained |
|---|---|---|
| 1.0 cc Mixor | 10 | 10 |
| Calmar TS-800-2G | 10 | 10 |
| Indesco T-8500 | 10 | 2 |
| Calmar TS-800-2E | 10 | 3 |

This shows that spray dispensers that provide the desired spray pattern according to the present invention, have a reduced tendency to stain fabrics treated with the wrinkle controlling composition.

### EXAMPLE IV

This Example demonstrates the affect a spray dispenser having a particular spray pattern has on the amount of time required for a fabric to dry which has been treated with a wrinkle controlling composition.

In this Example, a variety of spray dispensers are tested according to the Dry Time Test method disclosed in Section III.C. supra. The following wrinkle controlling composition of the present invention is used to evaluate the spray dispensers according to the Dry Time Test:

| Composition | Active Weight |
|---|---|
| Luviflex Soft¹ | 0.7% |
| Silwet L7001² | 1.5% |
| LaraCare A200³ | 0.5% |
| Hydroxylpropyl-β-cyclodextrin | 0.35% |
| Ethanol | 3.0% |
| Perfume | 0-0.04% |
| Preservative | 0-0.02% |
| PH | 5-6 |
| Water | Balance |

¹Ethylacrylate methacrylic acid copolymer (approximately 250,000 MW) available from BASF.
²Silicone glycol copolymer available from CK-Witco.
³Arabinoglactan polysaccharide (approximately 20,000 MW) available from Larex.

The data from the Dry Time Test method is collected for the given spray dispensers and plotted as a function of time vs. percent composition remaining. This data is represented in graphical form in FIG. 17. The data shows that the selection of the spray dispenser can have an affect on the amount of time required for a fabric treated with a wrinkle controlling composition to dry. The preferred spray dispensers herein exhibit faster dry times.

### EXAMPLE V

| | Tilt | Tilt | | | | | |
|---|---|---|---|---|---|---|---|
| | Angle | Angle | | | | Height | Height |
| | Spray | Spray | | | | w/ out | w/ |
| | ⊥ to | // to | Capacity | | Foot Print | trigger | trigger |
| Container | Beam | Beam | (ml) | Shape | Axes (cm) | sprayer | sprayer |
| FIT ® Fruit & | 31.3° | 17° | 250 | Round body | 7.0 × 4.5 | 14.0 | 18.0 |
| Veg. Wash | | | | w/ extended | [31.2] | | |
| Bottle | | | | neck | | | |
| Bath & | 20.3° | 9.3° | 236 | Long, | 6.5 × 3 | 14.0 | 19.4 |
| Bodyworks | | | | approximately | [19.5] | | |
| Refresher for | | | | rectangular | | | |
| Men | | | | | | | |
| TricorBaun ™ | 36.0° | 22.0° | 236 | Triangular | 8.9 × 5.1 | 11.4 | 15.6 |
| Triangular | | | | | | | |
| Bottle¹ | | | | | | | |
| FEBREZE ® | 14.1° | 11.7° | 118 | Long, | 5.1 × 3.8 | 11.9 | 16.2 |
| travel bottle | | | | approximately | | | |
| | | | | rectangular | | | |
| Bath & Body | 24.3° | 14.6° | 118 | Triangular | 6.7 × 4.1 | 9.8 | 14 |
| Works Art | | | | | | | |
| Stuff Cosmic | | | | | | | |
| Cool Body | | | | | | | |
| Splash | | | | | | | |
| Bath & Body | 9.8° | 8.4° | 118 | Irregular | NA foot print | 16.0 | 11.5 |
| Art Stuff | | | | | discontinuous | | |
| Cylindrical | 13.3° | 10.7° | 118 | Cylindrical | 4 × 4 | 12.0 | 16.51 |
| stock bottle | | | | | [12.6] | | |
| Cylindrical | 13.3° | 11.3° | 59 | Cylindrical | 3 × 3 | 9.5 | 14 |
| stock bottle | | | | | [7.1] | | |
| Cylindrical | 13.3° | 11.3° | 44 | Cylindrical | 3 × 3 | 8.0 | 12.4 |
| stock bottle | | | | | [7.1] | | |

For several of these containers, the percentage of mass that is present below one half of their height or the median of their height was calculated by the following procedure. The height of each container was measured and the median noted. Each container was then filled to the median and weighed without a dispener. The containers were then filled to capacity and weighed again. Based on these weight measurements, the percentage of mass that is held in the lower one half of each of the containers was calculated. These measurements and the calculations are presented in the following table.

| | Weight contained at ½ | % weight at ½ height of |
|---|---|---|
| Container (weight @ capacity) | height (g) | full weight |
| FIT ® Container | 187 | 74.8% |
| (250 g) | | |
| TricorBaun ™ Triangular Container | 175 | 74.2% |
| (236 g) | | |
| Bath & Body Art Stuff Cosmic Cool | 104 | 88.5% |
| Body Splash (118 g) | | |
| Bath & Body Art Stuff Glitter Splash | 92 | 78.2% |
| (118 g) | | |
| Bath & Body Men's Daily Refresher | 154 | 65.3% |
| (236 g) | | |
| Febreze ® Travel Size | 69 | 58.5% |
| (118 g) | | |
| Cylindrical Stock Bottle - 12 cm | 73 | 61.9% |
| (118 g) | | |

What is claimed is:

1. An article for use in maintaining the appearance and/or freshness of fabrics without the application of heat, the article comprising:
an aqueous composition selected from the group consisting of wrinkle control compositions, fabric refreshing compositions and mixtures thereof; and
a container for said aqueous composition, said container having a volume capacity between about 400 ml and about 100 ml and a spray dispenser that will provide a uniform spray pattern of the aqueous composition on fabric.

2. The article of claim 1, wherein said container has a volume capacity between about 350 ml and about 180 ml.

3. The article of claim 2, wherein said container has a volume capacity between about 300 ml and about 200 ml.

4. The article of claim 1, wherein the spray dispenser provides a uniform spray pattern having a volume per unit surface area of less than about 0.07 ml/inch² (0.011 ml/cm²).

5. The article of claim 4, wherein the spray dispenser provides a uniform spray pattern having a volume per unit surface area less than about 0.035 ml/inch² (0.0054 ml/cm²).

6. The article of claim 5, wherein the spray dispenser provides a uniform spray pattern having a volume per unit surface area less than about 0.02 ml/inch² (0.0031 ml/cm²).

7. The article of claim 1, wherein the spray dispenser provides a uniform spray pattern having a standard deviation in the volume per unit surface area of less than about 0.056 ml/inch² (0.0087 ml/cm²).

8. The article of claim 7, wherein the spray dispenser provides a uniform spray pattern having a standard deviation in the volume per unit surface area of less than about 0.03 ml/inch² (0.0047 ml/cm²).

9. The article of claim 8, wherein the spray dispenser provides a uniform spray pattern having a standard deviation in the volume per unit surface area of less than about 0.018 ml/inch² (0.0028 ml/cm²).

10. The article of claim 1, wherein the container has a perpendicular tilt angle equal to or greater than 10°.

11. The article of claim 10, wherein the container has a perpendicular tilt angle equal to or greater than about 20°.

12. The article of claim 11, wherein the container has a perpendicular tilt angle equal to or greater than about 30°.

13. The article of claim 1, wherein the container has a parallel tilt angle equal to or greater than 10°.

14. The article of claim 1, wherein at least about 50% of the mass of the container, when filled with an aqueous fabric care composition, is at or below the median point of the container's height.

15. The article of claims 14, wherein at least about 65% of the mass of the container, when filled with an aqueous fabric care composition, is at or below the median point of the container's height.

16. The article of claim 15, wherein at least about 70% of the mass of the container, when filled with an aqueous fabric care composition, is at or below the median point of the container's height.

17. A kit, comprising an article according to claim 1 and at least one accessory to facilitate the portability and/or effective use of the aqueous composition, said accessory selected from the group consisting of protective enclosures for containing the article, and hangers, compression devices, weights, portable mats, air blowers, gloves, mitts, mini irons for use in combination with the article, and combinations thereof.

18. The kit of claim 17, wherein the accessory is a protective enclosure having a moisture barrier to inhibit the transmission of moisture therethrough.

19. The kit of claim 17, wherein the protective enclosure is a pouch.

20. The kit of claim 17, further comprising a re-fill container for holding an aqueous composition.
